(19) United States
(12) Patent Application Publication
(10) Pub. No.: US 2015/0056604 A1
(43) Pub. Date: Feb. 26, 2015

(54) COMPOSITIONS AND METHODS FOR PRESERVING PLATELET FUNCTION

(71) Applicant: BIOVEC TRANSFUSION, LLC, Chicago, IL (US)

(72) Inventor: Lakshman R. SEHGAL, Monarch Beach, CA (US)

(21) Appl. No.: 14/510,915

(22) Filed: Oct. 9, 2014

Related U.S. Application Data
(63) Continuation-in-part of application No. 13/626,201, filed on Sep. 25, 2012.
Application No. 13/626,201 is a continuation-in-part of application No. 13/285,941, filed on Oct. 31, 2011, now Pat. No. 8,877,060.
Application No. 13/626,201 is a continuation-in-part of application No. 13/180,389, filed on Jul. 11, 2011, now Pat. No. 8,715,920.
Application No. 13/626,201 is a continuation-in-part of application No. 12/792,259, filed on Jun. 2, 2010.
(60) Provisional application No. 61/416,550, filed on Nov. 23, 2010.
(60) Provisional application No. 61/368,078, filed on Jul. 27, 2010.
(60) Provisional application No. 61/282,306, filed on Jan. 19, 2010.
(60) Provisional application No. 61/187,052, filed on Jun. 15, 2009.

(51) Int. Cl. A01N 1/02; B01D 61/14

(52) U.S. Cl. CPC A01N 1/0226; B01D 61/147; B01D 2315/10; B01D 2315/16
USPC 435/2

(57) ABSTRACT

Compositions and methods for maintaining platelet functionality and extending the shelf-life of platelets are described. Platelet preservation compositions include a photosensitizer and a plurality of platelet preservation agents. A method for preserving platelets and extending their shelf-life includes irradiating a platelet mixture containing a photosensitizer under conditions sufficient to activate the photosensitizer and inactivate microbes in the platelet mixture to form a microbe-depleted platelet preparation. A plurality of platelet preservation agents are added to the microbe-depleted platelet preparation for extending the platelet shelf-life. Prior to transfusion, the photosensitizer and platelet preservation agents can be removed by diafiltration and/or the use of compound adsorption devices.

This application is a continuation-in-part application of U.S. patent application Ser. No. 13/626,201, filed Sep. 25, 2012. U.S. patent application Ser. No. 13/626,201 is a continuation-in-part application of U.S. patent application Ser. No. 13/285,941, filed on Oct. 31, 2011, which claims priority from U.S. Provisional Application Ser. No. 61/416,550, filed on Nov. 23, 2010. U.S. patent application Ser. No. 13/626,201 is also a continuation-in-part of U.S. patent application Ser. No. 13/180,389, filed on Jul. 11, 2011, now U.S. Pat. No. 8,715,920, which claims priority to U.S. Provisional Application Ser. No. 61/368,078, filed on Jul. 27, 2010. U.S. patent application Ser. No. 13/626,201 is also a continuation-in-part application of U.S. patent application Ser. No. 12/792,259, filed on Jun. 2, 2010, which claims priority from U.S. Provisional Application Ser. No. 61/282,306, filed on Jan. 19, 2010, and U.S. Provisional Application Ser. No. 61/187,052, filed on Jun. 15, 2009. The entirety of all the aforementioned applications is herein incorporated by reference.

### FIELD

The present application generally relates to compositions and methods for maintaining platelet functionality and extending the shelf-life of platelets. More particularly, the present invention relates to platelet preservation compositions comprising a photosensitizer and one or more platelet preservation agents, and methods for preserving platelets so as to increase shelf-life and for removing the photosensitizer and platelet preservation agents from the composition prior to platelet transfusion.

### BACKGROUND

When blood vessels are damaged, cell fragments released from the bone marrow, called platelets, adhere to the walls of blood vessels and form clots to prevent blood loss. It is important to have adequate numbers of normally functioning platelets to maintain effective clotting, or coagulation, of the blood. Occasionally, when the body undergoes trauma, or when the platelets are unable to function properly, it is necessary to replace or transfer platelet components of blood into a patient. Most commonly, platelets are obtained from volunteer donors either as a component of a whole blood unit, or via plateletpheresis (withdrawing only platelets from a donor and re-infusing the remaining of the blood back into the donor). The platelets then are transferred to a patient as needed, a process referred to as “platelet transfusion.”

Platelet transfusion is indicated under several different scenarios. For example, an acute blood loss, either during an operation or as a result of trauma, can cause the loss of a large amount of platelets in a short period of time. Platelet transfusion is necessary to restore a normal ability to control blood flow, or hemostasis. In a medical setting, an individual can develop a condition of decreased number of platelets, a condition known as thrombocytopenia. The condition can occur as a result of chemotherapy, and requires platelet transfusion to restore normal blood clotting.

Unlike red blood cells, which can be stored for forty-five (45) days, platelets can be stored for a few days. Platelet sterility is difficult to maintain because platelets cannot be stored at low temperatures, for example 4° C. to 5° C. A low storage temperature for platelets initiates an activation process that leads to aggregation and cell death. Bacterial growth in the platelet medium at suitable storage temperatures, e.g., room temperature, can lead to an unacceptable occurrence of bacterial contamination in platelets used for transfusion. In fact, bacterial contamination of platelet products has been recognized as the most frequent infectious risk from transfusion, occurring in approximately 1 of 2000 to 1 of 3000 whole blood derived random donor platelets or apheresis derived single donor platelets. In the U.S.A., bacterial contamination is considered to be the second most common cause of death overall, from transfusion, with mortality rates ranging from 1:20,000 to 1:85,000. As a result, the Food and Drug Administration (FDA) limits the storage time of platelets to five (5) days, thereby safeguarding the transfusion supply from bacterial contamination.

Over the past two decades considerable progress has been made in the development of pathogen reduction technologies (PRT) for blood and blood products. Some of these are currently used routinely by blood banks. These technologies are based on the use of photosensitizers that are added prior to radiation exposure which results in oxygen radicals. Alternatively, they utilize electron transfer processes that are not dependent on oxygen, and target nucleic acids (photodynamic reaction). For example, there are a class of agents that form irreversible crosslinks to nucleic acids (photochemical reactions) in contaminating microbes, including bacteria and viruses, thereby preventing transcription and translation from microbial DNA so as to prevent their replication and cause their death. Anucleated red blood cells, platelets and plasma are largely spared this fate, since they lack nuclear DNA which would be otherwise targeted for cell death.

There are two platelet PRTs currently in use in the United States and both are based on photochemical treatments. The INTERCEPT Blood System (Cerus Corporation, Concord, Calif.) employs amotosalen-HCl and UV-A exposure. The MIRASOL Pathogen Reduction Technology System (Terumo BCT, Lakewood, Colo.) employs riboflavin and UV-B exposure. Although these PRT technologies have demonstrated effective reduction (4 to 6 logs) of tested microbes, they are not without adverse effects on platelets.

While PRT technologies can provide platelets that are adequate in vitro functionality, the in vivo parameters such as 24 hour CCI (corrected count increment) and circulation half-life show room for improvement. The adverse effects are largely attributed to platelet storage lesion (PSL). PSL is defined as the sum of the changes that occur in platelets following their collection, preparation, and storage, and accounts for the loss of platelet functionality that increases with increased duration of storage. PSL correlates with reduced in vivo recovery/survival and hemostatic capacity after transfusion and is characterized essentially by morphological and molecular evidence of platelet activation and energy consumption in the medium. PSL is characterized metabolically by a pH decrease associated with lactic acid generation; platelet activation characterized by increases in expression of P-selectin (CD62P) and soluble glycoprotein V (sGPV); loss of signaling responses to agonists; impaired platelet activation, secretion and aggregation; a change in platelet morphology from discoid to spherical; increased platelet phosphatidylserine exposure; formation of micro aggregates; release of alpha granules; apoptosis-specific morphologic and biochemical changes; a diminished response to in vitro challenge tests, such as the hypotonic shock response (HSR) and extent of shape change (ESC); increased surface P-selectin expression; reduction in the in vivo CCI; reduction in the circulating half-life of platelets; and decreased in vivo recovery and survival.

PSL is greatly influenced by factors including duration of storage, temperature, ratio of platelet number to media volume, solution composition with respect to energy content and buffering capacity, and gas permeability of the container. Processes that limit shelf-life are multifactorial, and include both necrosis and apoptosis, which are not limited to nucleated cells as once believed. Platelets are typically stored for up to five days at 22° C. on a shaking device before having to be used in a medical procedure, e.g., transfusion. Endogenously produced platelets circulate in normal humans for about 10 days. Stored platelets survive less well, particularly when they have been derived from whole blood and not prepared by apheresis.

The existing sterilization methods do not extend storage life of platelet but, on the contrary, appear to result in the significant loss of platelet function and reduction in the in vivo CCI and circulating half-life by activating platelets. Photochemical treatments prevent replication of microbes in platelet concentrates (PCs) by cross-linking nucleic acids and thus affects all cells containing DNA or RNA. Platelets contain mitochondrial DNA, which can be similarly targeted by the photosensitizers. Mitochondria are not only essential for energy homeostastis in most cell types, but also regulate intracellular signaling though the production of reactive oxygen species (ROS) and initiate apoptosis through the release of cytochrome c. Moreover, ultraviolet light used to photochemically activate photosensitizers is known to create oxidative stress, which is known to result in the production of ROS and inflammatory mediators implicated in tissue injury in various systems. Independent of photosensitizers and ultraviolet light exposure, increased platelet storage time is associated with mitochondrial dysfunction and an increase in reactive oxygen species.

Altering storage conditions to improve these measures can allow for extension of the duration of in vitro storage. To effectively extend the shelf-life of platelets, not only are sterilization methods for preventing contamination of the platelets important, but also methods for protecting the platelets during and after sterilization. It would also be beneficial to provide a convenient, effective platelet preservation composition for prolonging the functionality, integrity and shelf-life of the platelets. In addition, it would be beneficial to provide a method or composition for storing platelets that requires less management of the surrounding platelet storage environment.

### SUMMARY

One aspect of the present application relates to a method for preserving platelets, which includes irradiating a platelet mixture having an effective amount of a photosensitizer under conditions sufficient to activate the photosensitizer and inactivate microbes in the platelet mixture to form an irradiated microbe-depleted platelet preparation. Platelet preservation agents are added to the irradiated microbe-depleted platelet preparation, including a platelet activation inhibitor in the form of a GPIIb antagonist, GPIIIa antagonist, bifunctional inhibitor of both GPIIb and IIIa, P2Y12 receptor antagonist, second messenger effector or combination thereof; and an anticoagulant in the form of a factor Xa inhibitor or factor IIa inhibitor, thereby forming a platelet preservation composition.

In another embodiment, one or more preservation agents are added to the platelet mixture prior to the irradiation step.

In certain embodiments, the platelet activation inhibitor is a GPIIb or GPIIIa antagonist and the anticoagulant is a thrombin inhibitor. In a particular embodiment, the platelet activation inhibitor is tirofiban and the anticoagulant is argatroban.

In another embodiment, at least one mitochondrial-targeted antioxidant is further added to the irradiated microbe-depleted platelet preparation. In certain particular embodiments, the mitochondrial-targeted antioxidant is mitoquinone, mitoquinol, MitoQ, Mito-TEMPOL, MitoVit E or MitoPBN.

In some embodiments, the photosensitizer is riboflavin, psoralen, amotosalen or methylene blue.

In other embodiments, additional preservation agents are added to the microbe-depleted platelet mixture before or after irradiation, including one or more platelet storage lesion (PSL) inhibitors selected from the group consisting of calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combinations thereof.

In one embodiment, a calpain inhibitor is added to the microbe-depleted platelet mixture, such as PD150606, PD151746, calpastatin, calpeptin, ABT-099, A-965431, A-705253, A-705239, MDL28170, Z-LLY-fmk, Z-VAD-fmk or ALLN.

In another embodiment, a cyclophilin D inhibitor is added to the microbe-depleted platelet mixture, such as cyclosporin A, rotenone of oligomycin.

In another embodiment, an inhibitor of p38 mitogen activated protein kinase is added to the microbe-depleted platelet mixture, such as SB202190, SB203580 or LY294002.

In another embodiment, a phosphoinositide-3-kinase/Akt signaling pathway inhibitor is added to the microbe-depleted platelet mixture. The phosphoinositide-3-kinase/Akt signaling pathway inhibitor may target, for example, phosphoinositide 3-kinase (PI3K), phosphoinositide-dependent protein kinase 1 (PDK1), protein kinase B, glycogen synthase or kinase 3β (GSK-3β).

In one embodiment, a chloride channel inhibitor is added to the microbe-depleted platelet mixture, such as CaCCinh-A01, T16Ainh-A01 or NPPB.

In another embodiment, a calcium modulating agent is added to the microbe-depleted platelet mixture, such as BAPTA, EGTA, CDTA, BAPTA-AM, EGTA-AM or CDTA-AM.

In another embodiment, a caspase inhibitor is added to the microbe-depleted platelet mixture, such as Z-DEVD-fmk, Ivachtin, AZ 10417808 or Z-VAD-fmk.

In another embodiment, a protein synthesis inhibitor is added to the microbe-depleted platelet mixture, such as zilascorb zilascorb(2H), anisomycin, emetine and rapamycin.

In another embodiment, a sialidase inhibitor is added to the microbe-depleted platelet mixture.

In a further step, one or more of the photosensitizers or platelet preservation agents may be removed from the microbe-depleted preserved platelet preparation.

In one embodiment, the photosensitizers and/or platelet preservation agents are removed with a compound adsorption device.

In one embodiment, the photosensitizers and/or platelet preservation agents are removed by tangential flow filtration (TFF). In a particular embodiment, the photosensitizers and/or platelet preservation agents are removed using a TFF device having a TFF filter with an average pore size of 500 dalton to 5 μm. In certain embodiments, the TFF device is a diafiltration device with a diafiltration buffer. The TFF device may further employ a TFF filter in the form of a hollow fiber membrane filter.

Another aspect of the present invention relates to a platelet preservation composition that preserves the freshness of platelets and/or extends the shelf-life of donated platelets.

In one embodiment, the preservation composition comprises a photosensitizer and one or more preservation agents. When exposing a preservation composition containing platelets to ultraviolet light, the photosensitizer kills bacteria and viruses by a photoradiation process to improve platelet quality and the preservation agents protect the platelets from the adverse effect of the ultraviolet light and prevent or reduce one or more aspects of platelet storage lesion, before, during and/or after the microbe inactivation process.

Following irradiation, the photosensitizer, as well as other preservation agents, may be removed from the platelet preparation prior to platelet transfusion by adsorption to a compact adsorption device (CAD) or by tangential flow filtration (TFF).

In one embodiment, the platelet preservation composition comprises a photosensitizer, a platelet activation inhibitor and an anticoagulant.

In other embodiments, the platelet preservation composition further comprises one or more preservative agents, such as non-steroidal anti-inflammatory drugs, oxygen carriers, and anti-microbial agents.

In a further embodiment, the preservation composition comprises a mitochondrial-targeted antioxidant.

In another embodiment, the preservation composition comprises a mitochondrial-targeted antioxidant and one or more PSL inhibitor(s) selected from the group consisting of calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof.

In a further embodiment, the preservation composition a photosensitizer and mitochondrial-targeted antioxidant.

In a particular embodiment, the preservation composition includes a photosensitizer selected from the group consisting of riboflavin, psoralen or amotosolen; a platelet activation inhibitor selected from the group consisting of GPIIb antagonists, GPIIIa antagonists, bifunctional inhibitors of both GPIIb and IIIa, thrombin antagonists, P2Y12 receptor antagonists, second messenger effectors, derivatives thereof, and combinations thereof; an anticoagulant selected from the group consisting of factor Xa inhibitor and factor IIa inhibitor; and a PSL inhibitor selected from the group consisting of mitochondrial-targeted antioxidant, calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof, wherein said PSL inhibitor is present in an amount effective to reduce or prevent one or more changes characteristic of platelet storage lesion.

In a further aspect, a preserved platelet preparation includes an irradiated platelet preparation and one or more platelet preservation agents described herein. As used herein, the term “microbe-depleted” refers to an irradiated platelet preparation that has undergone photodynamic microbe inactivation.

In one embodiment, the preserved platelet preparation includes an irradiated platelet preparation, a platelet activation inhibitor and an anticoagulant. Alternatively, or in addition, the preserved platelet preparation includes an irradiated platelet preparation and a PSL inhibitor selected from the group consisting of mitochondrial-targeted antioxidant, calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof, wherein the PSL inhibitor is present in an amount effective to reduce or prevent one or more changes characteristic of platelet storage lesion.

### BRIEF DESCRIPTION OF FIGURES

FIG. 1 shows representative chromatograms from samples after diafiltration. The four traces in each chromatogram are: bottom trace—blank control; 2^{nd} trace from bottom—5 μg/mL argatroban control; 3^{rd} trace from bottom—0.25 μg/mL eptifibatide control (samples 5-7) or 0.25 μg/mL tirofiban control (samples 8-10); top trace—diafiltered samples, samples 5-7 were spiked with either 0.1 μg/mL tirofiban and 8 μg/mL argatroban before diafiltration, samples 8-10 were spiked with 0.1 μg/mL tirofiban and 8 μg/mL argatroban before diafiltration.

FIGS. 2A and 2B show the photo-degradation profile of argatroban at 282 nm. FIG. 2A shows HPLC traces of argatroban samples after various exposures to UV (trace A-F), the positive control (unexposed 50 μg/mL argatroban) and a the negative control (saline blank). FIG. 2B is a graphical representation of the loss in peak height associated with the exposure to UV₂₈₂, expressed as % relative to the positive control with standard deviations shown.

FIGS. 3A and 3B shows the photo-degradation profile of argatroban at 308 nm. FIG. 3A shows HPLC traces of argatroban samples after various exposures to UV (trace A-F), the positive control (unexposed 50 μg/mL argatroban) and a the negative control (saline blank). FIG. 3B is a graphical representation of the loss in peak height associated with the exposure to UV₃₀₈, expressed as % relative to the positive control with standard deviations shown.

FIG. 4 shows HPLC traces reflecting an identical pattern of photodegradation products at UV_{282 nm} and UV_{308 nm} in the two sets of experiments exemplified in FIGS. 2 and 3.

FIGS. 5A-5B show the photo-degradation profile of tirofiban at UV_{282 nm}. FIG. 5A shows HPLC traces of tirofiban samples after various exposures to UV (trace A-F), the positive control (unexposed 50 μg/mL argatroban) and a the negative control (saline blank). FIG. 5B is a graphical representation of the loss in peak height associated with the exposure to UV₂₈₂, expressed as % relative to the positive control with standard deviations shown. Traces E and F were below the lower limits of quantitation (LLOQ) for the assay.

FIGS. 6A-6B show the photo-degradation profile of tirofiban at UV₃₀₈. FIG. 6A shows HPLC traces of tirofiban samples after various exposures to UV (trace A-C), the positive control (unexposed 50 μg/mL argatroban) and a the negative control (saline blank). FIG. 6B is a graphical representation of the loss in peak height associated with exposure to UV₃₀₈, expressed as % relative to control with standard deviations shown.

FIGS. 7A-7B show the photo-degradation profile of eptifibatide at UV_{282 nm}. FIG. 7A shows HPLC traces of eptifibatide samples after various exposures to UV (trace A-F), the positive control (unexposed 50 μg/mL argatroban) and a the negative control (saline blank). FIG. 7B is a graphical representation of the loss in peak height associated with the exposure to UV₃₀₈, expressed as % relative to control with standard deviations shown.

FIGS. 8A-8B show the photo-degradation profile of eptifibatide at UV_{308 nm}. FIG. 8A shows HPLC traces of eptifibatide samples after various exposures to UV (trace A-F), the positive control (unexposed 50 μg/mL argatroban) and the negative control (saline blank). FIG. 8B is a graphical representation of the loss in peak height associated with the exposure to UV₃₀₈, expressed as % relative to control and with standard deviations shown.

### DETAILED DESCRIPTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

### Preservation Composition

One aspect of the present invention relates to a platelet preservation composition that preserves the freshness of platelets and/or extends the shelf-life of donated platelets. In one embodiment, the preservation composition comprises a photosensitizer and one or more preservation agents.

When exposing a preservation composition containing platelets to ultraviolet light, the photosensitizer kills bacteria and viruses by a photoradiation process to improve platelet quality and the preservation agents protect the platelets from the adverse effect of the ultraviolet light and prevent or reduce one or more aspects of platelet storage lesion, before, during and/or after the microbe inactivation process.

Following irradiation, the photosensitizer, as well as other preservation agents, may be removed from the platelet preparation prior to platelet transfusion by adsorption to a compact adsorption device (CAD) or by tangential flow filtration (TFF).

In one embodiment, the platelet preservation composition comprises a photosensitizer, a platelet activation inhibitor and an anticoagulant.

In other embodiments, the platelet preservation composition further comprises one or more preservative agents, such as non-steroidal anti-inflammatory drugs, oxygen carriers, and anti-microbial agents.

In one embodiment, the preservation composition comprises a mitochondrial-targeted antioxidant.

In another embodiment, the preservation composition comprises a mitochondrial-targeted antioxidant and one or more PSL inhibitor(s) selected from the group consisting of calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof.

In a further embodiment, the preservation composition a photosensitizer and mitochondrial-targeted antioxidant.

In a further embodiment, the preservation composition includes a photosensitizer selected from the group consisting of riboflavin, psoralen or amotosolen; a platelet activation inhibitor selected from the group consisting of GPIIb antagonists, GPIIIa antagonists, bifunctional inhibitors of both GPIIb and IIIa, thrombin antagonists, P2Y12 receptor antagonists, second messenger effectors, derivatives thereof, and combinations thereof; an anticoagulant selected from the group consisting of factor Xa inhibitor and factor IIa inhibitor; and a PSL inhibitor selected from the group consisting of mitochondrial-targeted antioxidant, calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof, wherein said PSL inhibitor is present in an amount effective to reduce or prevent one or more changes characteristic of platelet storage lesion.

In yet another embodiment, the preservation composition comprises a mitochondrial-targeted antioxidant and one or more PSL inhibitor(s) selected from the group consisting of calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof.

Photosensitizers

The photosensitizer is used in a photoradiation process to promote microbe killing and improve platelet quality. The term “photosensitizer” as used herein refers to a compound which absorbs radiation at one or more defined wavelengths and has the ability to utilize the absorbed energy to carry out a chemical process, such as facilitating the formation of phototoxic species sufficient for killing one or more microbes. A photosensitizer is “sensitive to” or “sensitized by” radiation at a wavelength if it absorbs the radiation at this wavelength.

In one embodiment, the photosensitizer is sensitive to ultraviolet (UV) light. Exemplary UV-sensitive photosensitizers include riboflavin and amotosalen. Whereas riboflavin is sensitive to UV-B light (280-320 nm), amotosalen is sensitive to UV-A light (320-400 nm).

In one embodiment, the photosensitizer is sensitive to visible light (430-790 nm). Methylene blue is an exemplary visible light sensitive photosensitizer. Methylene blue and other visible light sensitive photosensitizers may offer the advantage of reducing the level of non-specific damage by reactive oxygen species (ROS) to mitochondria so as to reduce platelet storage lesion.

In another embodiment, the photosensitizer is sensitive to non-UV light, including longer wavelengths ranging from about 600 to about 1200 nm.

In a related embodiment, a combination of photosensitizers may be utilized, wherein at least one is sensitive to UV light and one is sensitive to non-UV light.

Exemplary photosensitizers include, but are not limited to, riboflavin, psoralen, amotosalen, quinoline, quinolones, nitric oxide, pyrrole derived macrocyclic compounds, naturally occurring or synthetic porphyrins and derivatives thereof naturally occurring or synthetic chlorins and derivatives thereof, naturally occurring or synthetic bacteriochlorins and derivatives thereof, naturally occurring or synthetic isobacteriochlorins and derivatives thereof, naturally occurring or synthetic phthalocyanines and derivatives thereof, naturally occurring or synthetic naphthalocyanines and derivatives thereof, naturally occurring or synthetic porphycenes and derivatives thereof, naturally occurring or synthetic porphycyanines and derivatives thereof, naturally occurring or synthetic pentaphyrins and derivatives thereof, naturally occurring or synthetic sapphyrins and derivatives thereof, naturally occurring or synthetic benzochlorins and derivatives thereof, naturally occurring or synthetic chlorophylls and derivatives thereof, naturally occurring or synthetic azaporphyrins and derivatives thereof, the metabolic porphyrinic precursor 5-amino levulinic acid and any naturally occurring or synthetic derivatives thereof, PHOTOFRIN™, synthetic diporphyrins and dichlorins, O-substituted tetraphenyl porphyrins (picket fence porphyrins), 3,1-meso tetrakis (o-propionamido phenyl) porphyrin, verdins, purpurins (e.g., tin and zinc derivatives of octaethylpurpurin (NT2), and etiopurpurin (ET2)), zinc naphthalocyanines, anthracenediones, anthrapyrazoles, aminoanthraquinone, phenoxazine dyes, chlorins (e.g., chlorin e6, and mono-1-aspartyl derivative of chlorin e6), benzoporphyrin derivatives (BPD) (e.g., benzoporphyrin monoacid derivatives, tetracyanoethylene adducts of benzoporphyrin, dimethyl acetylenedicarboxylate adducts of benzoporphyrin, Diels-Adler adducts, and monoacid ring “a” derivative of benzoporphyrin), low density lipoprotein mediated localization parameters similar to those observed with hematoporphyrin derivative (HPD), sulfonated aluminum phthalocyanine (Pc) (sulfonated AIPc, disulfonated (A1PcS₂), tetrasulfonated derivative, sulfonated aluminum naphthalocyanines, chloroaluminum sulfonated phthalocyanine (CASP)), phenothiazine derivatives, chalcogenapyrylium dyes cationic selena and tellurapyrylium derivatives, ring-substituted cationic PC, pheophorbide alpha, hydroporphyrins (e.g., chlorins and bacteriochlorins of the tetra(hydroxyphenyl) porphyrin series), phthalocyanines, hematoporphyrin (BP), protoporphyrin, uroporphyrin III, coproporphyrin III, protoporphyrin IX, 5-amino levulinic acid, pyrromethane boron difluorides, indocyanine green, zinc phthalocyanine, dihematoporphyrin (514 nm), benzoporphyrin derivatives, carotenoporphyrins, hematoporphyrin and porphyrin derivatives, rose bengal (550 nm), bacteriochlorin A (760 nm), epigallocatechin, epicatechin derivatives, hypocrellin B, urocanic acid, indoleacrylic acid, rhodium complexes, etiobenzochlorins, octaethylbenzochlorins, sulfonated Pc-naphthalocyanine, silicon naphthalocyanines, chloroaluminum sulfonated phthalocyanine (610 nm), phthalocyanine derivatives, iminium salt benzochlorins and other iminium salt complexes, Merocyanin 540, Hoechst 33258, and other DNA-binding fluorochromes, acridine compounds, suprofen, tiaprofenic acid, non-steroidal anti-inflammatory drugs, methylpheophorbide-a-(hexyl-ether) and other pheophorbides, furocoumarin hydroperoxides, Victoria blue BO, methylene blue, toluidine blue, porphycene compounds, indocyanines coumarins or other polycyclic ring compounds, hypericins, free radical and reactive forms of oxygen, phenothiazin-5-ium dyes, and combinations of the above. The entire contents of the above-mentioned U.S. patents are herein incorporated by reference.

The photosensitizer may be an endogenous photosensitizer or a non-endogenous photosensitizer. The term “endogenous” as used herein refers to photosensitizers naturally found in a human or mammalian body, either as a result of synthesis by the body, ingestion (e.g. vitamins), or formation of metabolites and/or byproducts in vivo. Exemplary endogenous photosensitizers include, but are not limited to, alloxazines, such as 7,8-dimethyl-10-ribityl isoalloxazine (riboflavin or vitamin B2), 7,8,10-trimethylisoalloxazine (lumiflavin), 7,8-dimethylalloxazine (lumichrome), isoalloxazine-adenine dinucleotide (flavine adenine dinucleotide [FAD]), alloxazine mononucleotide (also known as flavine mononucleotide [FMN] and riboflavine-5-phosphate), vitamin Ks, including vitamin K1, vitamin K1 oxide, vitamin vitamin K5, vitamin K-S (II), vitamin K6, vitamin K7, vitamin L, their metabolites and precursors, and napththoquinones, naphthalenes, naphthols and their derivatives having planar molecular conformations. The term “alloxazine” includes isoalloxazines. Endogenously-based derivative photosensitizers include synthetically derived analogs and homologs of endogenous photosensitizers which may have or lack lower (1-5) alkyl or halogen substituents of the photosensitizers from which they are derived, and which preserve the function and substantial non-toxicity thereof.

In a particular embodiment, the photosensitizer is a compound preferentially adsorbing to nucleic acids, such as riboflavin, psoralen and amotosalen, thereby focusing its photodynamic effects upon microorganisms and viruses with little or no effect upon accompanying platelets and other non-nucleated cells or proteins.

In some embodiments, riboflavin is used in the concentration range of 1-200 μM, 25-150 μM, or 50-100 μM. In other embodiments, the photosensitizer is psoralen. In other embodiments, psoralen is used in the concentration range of 1-200 μM, 25-150 μM, or 50-100 μM. Amotosalen may be used in the concentration range of 1-200 μM, 25-150 μM, or 50-100 μM. In yet other embodiments, the photosensitizer is methylene blue, which may be used in the concentration range of 0.2-50 μM, 1-20 μM, or 2.5-10 μM.

The photosensitizer is added in an amount sufficient to inactivate microbes, including both non-pathogenic and pathogenic microbes. The microbes include bacteria, viruses, fungi and the like. The photosensitizer is added in an amount sufficient for inactivating one or more microbes, but in an amount substantially non-toxic to platelets and/or other humans or other mammals upon transfusion. The effective concentration varies for each particular photosensitizer. There is a reciprocal relationship between photosensitizer compositions and light dose, thus, determination of effective concentration, suitable wavelength, light intensity, and duration of illumination is within the level of ordinary skill in the art.

Photodynamic Microbial Inactivation without Photosensitizers

As an alternate to microbe inactivation using photosensitizers, platelet preservation compositions and preserved platelet preparation of the present invention may be utilized in conjunction with chemical-free photodynamic methodologies.

In one embodiment, microbe inactivation is carried out using short-wave UV-C radiation (200-280 nm). This approach is used for direct killing of microbes in the THERAFLEX UV-Platelets system employed in Europe.

In another embodiment, microbe inactivation is carried out using a low power ultrashort pulsed visible femtosecond laser (at e.g., 425 nm) to inactivate microbes as described in US 2008/0299636, the disclosures of which are incorporated by reference herein. In this approach, the femtosecond laser excites the vibrational states of microorganisms using ultrashort, low energy pulses in ranges of the electromagnetic spectrum to which water is essentially transparent. In particular, this visible femtosecond laser system excites a coherent acoustic Raman-active vibrational mode in microorganisms through Impulsive Stimulated Raman Scattering (ISRS) to a state that leads to a selective diminution of their activity that includes their inactivation through mechanical acoustic excitations.

In one embodiment, the a laser produces pulses on the order of femtoseconds with a given repetition rate. A second harmonic generator is used to irradiate the sample. Mirrors reflect the beam to a focusing lens that focuses the beam into the sample container. The focus of the beam defines the sample container into an area in which the beam is intensely focused and an area in which the beam is less intensely focused.

An exemplary laser for use to produce the ultrashort pulsed radiation is a diode-pumped cw mode-locked Titanium-sapphire laser. However, other femtosecond lasers may be employed. Such femtosecond lasers include ring lasers, argon-pumped dual-jet dye lasers, or the second harmonic output of a YAG lasers, ultrashort pulsed fiber lasers. Other Ti:sapphire lasers include integrated pump lasers such as the Pallas-LP from Time-Bandwidth Products, cavity-dumped femtosecond Ti:sapphire laser systems such as the Tiger-CD tunable Nd: glass lasers such as the GLX-200 from Time-Bandwidth Products, or passively mode-locked thin disk lasers such as the Fortis from Time-Bandwidth Products.

The laser can be set to produce a continuous train of pulses at a set repetition rate. Preferably, the pulses are about 80 femtoseconds in width and the repetition rate is about 80 MHz, the wavelength is about 425 nm, and the power is about 40 mW. However, other settings may be used. For example, pulse widths from about one attosecond to about one picosecond may be used and wavelengths from about 400 nm to about 900 nm may be used.

Preferably, the harmonic generation system may be a BBO nonlinear crystal, but other nonlinear crystals for doubling the near infrared to visible light may be used. These alternatives include LBO, LiNbO3, KTP, LiTaO3, KNbO3, KDP, CLBO, BIBO, CBO, ZGP, AgGaS2, AgGaSe2, CdSe, and GaAs nonlinear crystals.

The focusing lens can be a microscope objective with an extra long working distance, preferably about 2.0 cm. However, other focusing lenses with different working distances may be employed. Focusing lenses may include compound lenses or fiber optics lenses. Adjustments may be made to focus the laser to inactivate microorganisms present in a platelet solution.

By use of impulsive stimulated Raman scattering, selective inactivation of microbes may be achieved with a femtosecond laser. In certain embodiments, microbes may be subjected to pulses at a wavelength of 425 nm with a pulse width of 100 fs. Different settings may be successively utilized in order to substantially inactivate all microorganisms. Accordingly for different types of microorganisms, the wavelength and pulse width may be appropriately selected with a corresponding window in power density that enables the selective inactivation of target viruses and bacteria without causing cytotoxicity in mammalian cells.

Platelet Preservation Agents

A platelet preservation agent is an additive or agent capable of preserving the activity, reducing platelet storage lesion in a platelet preparation and/or extending the shelf-life of platelets treated therewith. A plurality of platelet preservation agents may be added to a platelet mixture, the irradiated platelet preparation, or both. Thus, one or more platelet preservation agents may be present in a platelet preparation before and/or after the irradiation of the platelets in the presence of the photosensitizer.

Exemplary platelet preservation agents for use in the present invention include, but are not limited to, platelet activation inhibitors, anticoagulants, oxygen carriers, non-steroidal anti-inflammatory drugs, anti-microbial agents, quenchers, platelet storage lesion (PSL) inhibitors, other additives, and any combinations thereof.

Preferably, the platelet preservation agent is cell permeable and its activity is reversible. As used herein, the term “reversible” or “reversibly” refers to an act, such as binding or associating, that is capable of reverting back to an original condition prior to the act, for example the state of being unbound or disassociated, either with or without the assistance of an additional constituent.

Platelet Activation Inhibitors

Platelet activation inhibitors include any agent that reversibly impedes platelet activation and/or aggregation by blocking sites on the platelet surface can be used as the antiplatelet agent in the present invention. Platelet activation inhibitors include, but are not limited to, GPIIb/IIIa antagonists including bifunctional inhibitors of both GPIIb and IIIa, thrombin antagonists, P2Y12 receptor antagonists, second messenger effectors.

In certain preferred embodiments, the GPIIb/IIIa antagonists are GPIIb/IIIa antagonists that bind GPIIb/IIIa sites in a reversible manner. Examples of such GPIIb/IIIa antagonists include eptifibatide (INTEGRILIN®, Schering-Plough Corporation, Kenilworth, N.J., U.S.A.), orbofiban, xemilofiban, lamifiban, tirofiban (AGGRASTAT®), abciximab (REOPRO®), lefradafiban, sibrafiban and lotrafiban. In one embodiment, the GPIIb/IIIa antagonists are bifunctional inhibitors of both GPIIb/IIIa as described in U.S. Pat. No. 5,242,810, which is incorporated herein by reference.

In another embodiment, the platelet activation inhibitors include one or more thrombin antagonists. These agents interact with thrombin and block its catalytic activity on fibrinogen, platelets and other substrates. Heparin and its derivatives (low molecular weight heparins and the active pentasaccharide) inhibit thrombin and/or other coagulation serine proteases indirectly via antithrombin, and the warfarin-type drugs interfere with the synthesis of the precursors of the coagulation serine proteases. Direct thrombin inhibitors approved for clinical use include lepirudin, desirudin, bivalirudin and argatroban.

In another embodiment, the platelet activation inhibitors include one or more P2Y12 receptor antagonists. Examples of P2Y12 receptor antagonists include, but are not limited to prasugrel ((5-(2-cyclopropyl-1-(2-fluorophenyl)-2-oxoethyl)-4,5,6,7-tetrahydrothieno[3,2-c]pyridin-2-yl acetate), IC50=1.8 μM), cangrelor (IC50=5.8-98 nM), and AZD6140 (ticagrelor, IC50=13 nM).

In another embodiment, the platelet activation inhibitors include one or more second messenger effectors. Second messenger effectors include any agent inhibiting a chemical pathway in a platelet so as to reduce platelet activation. Examples of second messenger effectors include, but are not limited to, “Thrombosol” (Life Cell Corp), linear or novel cyclic RGD peptide analogs, cyclic peptides, peptidomimetics, non-peptide analogs conjugated to nitric oxide donor, and the like, and mixtures thereof.

Second messenger effectors also include calcium sequestering agents, such as calcium channel blockers, α-blockers, β-adrenergic blockers and mixtures thereof as further described below.

In certain preferred embodiments, the platelet activation inhibitor has short-to-ultra short half-life. By short-to-ultra short half-life is meant that the platelet activation inhibitor is cleared from circulation within 15 minutes to 8 hours, preferably within 4 hours or less, after the infusion of the antiplatelet agent into the patient is stopped.

In one embodiment, the platelet activation inhibitor is an active agent that binds to or associates with the GPIIb/IIIa sites in a reversible manner and has a circulating half-life of inhibition of 4 hours or less. Short to ultra-short acting GPIIb/IIIa antagonist might include eptifibatide (INTEGRILIN®), tirofiban (AGGRASTAT®), abciximab (REOPRO®), lefradafiban, sibrafiban, orbofiban, xemilofiban, lotrafiban, XJ757, and XR299 (Class II).

In another embodiment, the platelet activation inhibitor is present in the composition at a final concentration equal to 10 times the maximum therapeutic concentration or as low as 5% of that therapeutic concentration. The term “therapeutic concentration” refers to the maximum plasma concentration achieved when the platelet activation inhibitor is administered at the recommended dose in patients with no renal or hepatic impairment.

In one embodiment, the preservation composition includes tirofiban. In another embodiment, the tirofiban is present in the composition at a final concentration of about 3 μg-3000 μg per unit of platelets. In another embodiment, the platelet activation inhibitor is tirofiban at a final concentration of about 100 μg per unit of platelets. Typically, a unit of platelets obtained by the buffy coat method contains about 3×10⁹ platelets in approximately 300 ml of plasma or other suitable preservation composition. A unit of platelets collected by apheresis usually contain 5×10¹¹ platelets in 300 ml of plasma typically, but can also be diluted to 30% plasma with a suitable plasma additive solution such as Intersol (Fenwal, Deerfield, Ill.). In other embodiments, the platelet activation inhibitor is tirofiban that is used at a final concentration that can range from 10 times the maximum therapeutic concentration to 5% of that concentration.

In one embodiment, the preservation composition includes eptifibatide. In another embodiment, the eptifibatide is present in the composition at a final concentration that is equivalent to 10 times the maximum therapeutic concentration in patients with no renal or hepatic impairment and as low as 5% of that concentration.

Anticoagulants

In another embodiment, the preservation composition further comprises one or more anticoagulants. Examples of anticoagulants include, but are not limited to, heparin, heparin substitutes, prothrombopenic anticoagulants, platelet phosphodiesterase inhibitors, dextrans, thrombin antagonists, and mixtures thereof.

Examples of heparin and heparin substitutes include, but are not limited to, heparin calcium, such as calciparin; heparin low-molecular weight, such as enoxaparin and lovenox; heparin sodium, such as heparin, lipo-hepin, liquaemin sodium, and panheprin; and heparin sodium dihydroergotamine mesylate.

Suitable prothrombopenic anticoagulants are, for example, anisindione, dicumarol, warfarin sodium, and the like. More specific examples of phosphodiesterase inhibitors suitable for use in the invention include, but are not limited to, anagrelide, dipyridamole, pentoxifyllin, and theophylline. Examples of dextrans include, for example, dextran 70, such as HYSKON® (CooperSurgical, Inc., Shelton, Conn., U.S.A.) and MACRODEX® (Pharmalink, Inc., Upplands Vasby, Sweden), and dextran 75, such as GENTRAN® 75 (Baxter Healthcare Corporation, Deerfield, Ill., U.S.A.).

The anticoagulants may also include Xa inhibitors, IIa inhibitors, and mixtures thereof. Various direct Xa inhibitors were synthesized and advanced to clinical development (Phase I-II) for the prevention and treatment of venous thromboembolic disorders and certain settings of arterial thrombosis [Hirsh and Weitz, Lancet, 93:203-241, (1999); Nagahara et al., Drugs of the Future, 20: 564-566, (1995); Pinto et al., 44: 566-578, (2001); Pruitt et al., Biorg. Med. Chem. Lett., 10: 685-689, (2000); Quan et al., J Med. Chem. 42: 2752-2759, (1999); Sato et al., Eur. J. Pharmacol., 347: 231-236, (1998); Wong et al, J. Pharmacol. Exp. Therapy, 292:351-357, (2000)]. A direct anti-IIa (thrombin) such as melagatran, the active form of pro-drug ximelagatran [Hirsh and Weitz, Lancet, 93:203-241, (1999); Fareed et al., Current Opinion in Cardiovascular, pulmonary and renal investigational drugs, 1:40-55, (1999)].

In certain embodiments, the anticoagulant is a short-to-ultra short acting anticoagulant. By short or ultra-short half-life is meant that the anticoagulant is cleared from circulation within 15 minutes to 8 hours after the infusion of the anticoagulant into the patient is stopped. In one embodiment, the short-to-ultra short acting anticoagulant is a short-to-ultra short acting factor Xa inhibitor with a circulating half-life of less than 4 hours. Examples of ultra-short acting factor Xa inhibitors include, but are not limited to, DX-9065a, RPR-120844, BX-807834 and SEL series Xa inhibitors.

DX-9065a is a synthetic, non-peptide, propanoic acid derivative, 571 D selective factor Xa inhibitor (Dai chi). It directly inhibits factor Xa in a competitive manner with an inhibition constant in the nanomolar range (Herbert et al., J. Pharmacol. Exp. Ther. 276:1030-1038 (1996); Nagahara et al., Eur. J. Med. Chem. 30 (suppl):140s-143s (1995)).

As a non-peptide, synthetic factor Xa inhibitor, RPR-120844 (Rhone-Poulenc Rorer), is one of a series of novel inhibitors which incorporate 3-(S)-amino-2-pyrrolidinone as a central template (Ewing et al., Drugs of Future 24(7):771-787 (1999)). This compound has a Ki of 7 nM with selectivity >150-fold over thrombin, activated protein C, plasmin and t-PA. It prolongs the PT and aPTT in a concentration-dependent manner, being more sensitive to the aPTT. It is a fast binding, reversible and competitive inhibitor of factor Xa.

BX-807834 has a molecular weight of 527 Da and a Ki of 110 μM for factor Xa as compared to 180 μM for TAP and 40 nM for DX-9065a (Baum et al., Circulation. 98 (17), Suppl 1: 179, (1998)).

The SEL series of novel factor Xa inhibitors (SEL-1915, SEL-2219, SEL-2489, SEL-2711: Selectide) are pentapeptides based on L-amino acids produced by combinatorial chemistry. They are highly selective for factor Xa and potency in the pM range. The Ki for SEL 2711, one of the most potent analogues, is 0.003 M for factor Xa and 40 M for thrombin (Ostrem et al., Thromb. Haemost. 73:1306 (1995); Al-Obeidi and Ostrem., Exp. Opin. Ther. Patents 9(7):931-953 (1999)).

In another embodiment, the short-to-ultra short acting anticoagulant is a short-to-ultra short acting factor IIa inhibitor. Examples of short-to-ultra short acting anticoagulant include, but are not limited to, DUP714, hirulog, hirudin, melgatran and combinations thereof.

In some embodiments, the anticoagulant is present in the composition at a final concentration that is equivalent to the maximum therapeutic concentration (APTT between 1.5 and 3 min) or up to 5% of the therapeutic concentration. The term “therapeutic concentration” refers to the maximum plasma concentration achieved in patient when the anticoagulant is administered at the recommended dose and maintains APTT between 1.5 and 3 min.

In some embodiments, the anticoagulant is argatroban. In other embodiments, the argatroban is present in the composition at a final concentration of about 15 μg-15 mg per unit of platelets. In another embodiment, the anticoagulant is argatroban at a final concentration of about 1500 μg is per unit of platelets. In other embodiments, the platelet activation inhibitor is eptifibatide and is used at a final concentration of about 50 μg/l, 150 μg/l, 500 μg/l, 1.5 mg/l. in the preserved platelet preparation.

Oxygen Carriers

The preservation composition may further comprise a pharmaceutically acceptable oxygen carrier. The oxygen carrier can be any suitable red blood cell substitute. In a preferred embodiment, the oxygen carrier is a hemoglobin-based oxygen carrier. Still more preferably, the oxygen carrier is an acellular hemoglobin-based oxygen carrier substantially free of red cell membrane (stroma) contaminants.

The use of a hemoglobin-based oxygen carrier, even in small volumes, as part of the platelet preservation composition provides significantly greater concentration of oxygen than amounts currently made available by the use of oxygen-permeable storage bags. Adding an oxygen carrier (e.g., a stroma-free hemoglobin solution) to platelets can allow for the use of gas impermeable bags, which reduces the high cost associated with using gas permeable bags.

The term “pharmaceutically acceptable oxygen carrier” as used herein refers to a substance that has passed the FDA human safety trials at a hemoglobin dosage of 0.5 g/kg body weight or higher. An oxygen carrier suitable for the invention can be hemoglobin, ferroprotoporphyrin, perfluorochemicals (PFCs), and the like. The hemoglobin can be from human or any other suitable mammalian source. In a preferred embodiment, the preservation composition has a hemoglobin concentration from the range of 1 to 18 gm/dl and a methemoglobin concentration of less than about 5%. The hemoglobin based oxygen carrier can be chemically modified to mimic the oxygen loading and unloading characteristics of fresh red blood cells. Additionally, the chemical modification can enhance the buffering capacity of the preferred embodiment and preserve normal physiologic pH.

Non-Steroidal Anti-Inflammatory Drugs

The preservation composition may further comprise one or more non-steroidal anti-inflammatory drugs (NSAIDS). The NSAIDS suitable for the invention can be salicylate-like or non-salicylate NSAIDS that bind reversibly and inhibit platelet aggregation in vitro, but are cleared rapidly, i.e. quickly eliminated from the body (typically, in less than about 2 hours after infusion). Examples of salicylate-like NSAIDS include, but are not limited to, acetaminophen, carprofen, choline salicylate, magnesium salicylate, salicylamide, sodium salicylate, sodium thiosulfate, and mixtures thereof. Examples of non-salicylate NSAIDS include, but are not limited to, diclofenac sodium, diflunisal, etodolac, fenoprofen calcium, flurbiprofen, hydroxychloroquin, ibuprofen, indomethacin, ketoprofen, ketorolac tromethamine, meclofenamate sodium, mefenamic acid, nabumetone, naproxen, naproxen sodium, oxyphenbutazone, phenylbutazone, piroxicam, sulfinpyrazone, sulindac, tolmetin sodium, dimethyl sulfoxide and mixtures thereof.

Anti-Microbial Agents

The preservation composition may comprise an anti-microbial agent, preferably a short-to-ultra-short acting broad spectrum anti-microbial agent. By short or ultra short acting anti-microbial agent is meant that the agent is cleared from circulation within 15 minutes to 8 hours after the infusion of the antimicrobial into the patient is stopped. Examples of such agents include, but are not limited to, penicillin, monobactam, cephalosporin, carbapenems, vancomycin, isoniazid (INH), ethambutol, aminoglycoside, tetracycline, chloramphenicol, macrolide, rifamycin, quinolone, fluoroquinolone, sulfonamide, polyene antibiotic, triazole, griseofulvin, and derivatives and combinations thereof.

Quenchers

Quenchers may also be added to the preservative composition to make the irradiation process more efficient and selective. Such quenchers include antioxidants or other agents to prevent damage to desired fluid components or to improve the rate of microbe inactivation and are exemplified by adenine, histidine, cysteine, tyrosine, tryptophan, ascorbate, N-acetyl-L-cysteine, propyl gallate, glutathione, mercaptopropionylglycine, dithiothreotol, nicotinamide, BHT, BHA, lysine, serine, methionine, glucose, mannitol, vitamin E, trolox, alpha-tocopheral acetate and various derivatives, glycerol, and mixtures thereof. Quenchers may be added to the platelet preservation composition in an amount necessary to prevent damage to the platelets.

Platelet Storage Lesion (PSL) Inhibitors

In a further aspect, the platelet preservation composition includes one or more platelet storage lesion (PSL) inhibitors. As used herein, a “PSL inhibitor” refers to an agent capable of reducing or preventing one or more changes characteristic of platelet storage lesion. These changes include, but are not limited to a pH decrease associated with lactic acid generation; platelet activation characterized by increases in expression of P-selectin (CD62P) and soluble glycoprotein V (sGPV); loss of signaling responses to agonists; impaired platelet activation, secretion and aggregation; a change in platelet morphology from discoid to spherical; increased platelet phosphatidylserine exposure; formation of micro aggregates; release of alpha granules; apoptosis-specific morphologic and biochemical changes; a diminished response to in vitro challenge tests, such as the hypotonic shock response (HSR) and extent of shape change (ESC); increased surface P-selectin expression; reduction in the in vivo CCI (corrected count increment); reduction in the circulating half life of platelets; and decreased in vivo recovery and survival.

PSL inhibitors include, but are not limited to mitochondrial-targeted antioxidants, calpain inhibitors, cyclophilin D inhibitors, p38 mitogen-activated kinase (MAPK) inhibitors, phosphoinositide-3-kinase/Akt signaling pathway inhibitors, chloride channel inhibitors, calcium modulating agents, caspase inhibitors, protein synthesis inhibitors and sialidase inhibitors.

In a particular embodiment, the PSL inhibitor is a mitochondrial-targeted antioxidant. Oxidative stress in the form of cellular reactive oxygen species (ROS) are known to be important transducers of cellular signaling that regulate cell growth, proliferation, differentiation and death. Mitochondrial-targeted antioxidants have been shown to inhibit H₂O₂-induced mitochondrial oxidative damage and cell death and mitochondrial ROS signaling.

Exemplary mitochondrial-targeted antioxidants include, but are not limited to mitoquinone (10-(4,5-dimethoxy-2-methyl-3,6-dioxo-1,4-cyclohexadien-1-yl)decyl]triphenylphosphonium methanesulfonate), mitoquinol, the reduced counterpart of mitoquinone; a mixture of mitoquinone and mitoquinol, also known as MitoQ; Mito-TEMPOL (2-(2,2,6,6-Tetramethylpiperidin-1-oxyl-4-ylamino)-2-oxoethyl)triphenylphosphonium chloride, MitoVit E ([2-(3,4-dihydro-6-hydroxy-2,5,7,8-tetra-methyl-2H-1-benzopyran-2-yl)ethyl]triphenylphosphonium bromide) and MitoPBN ([4-[4-[[(1,1-dimethylethyl)oxidoimino]-methyl]phenoxy]butyl]-triphenylphosphonium bromide.

In another embodiment, the PSL inhibitors include one or more calpain inhibitors. Calcium is a major second messenger in platelet activation, and elevated intracellular calcium leads to hyperactive platelets. Calcium-dependent calpains are a family of cysteine proteases that have been demonstrated to play key roles in both platelet glycoprotein Ibα shedding, platelet activation, disassembling the cytoskeleton and promoting the release of procoagulant microvesicles from platelet surfaces. Present in both the cytosol and intermembrane space of mitochondria, calpains are known to mediate mitochondrial damage during myocardial ischemia and reperfusion. Further, calpain activators are known to induce apoptosis-associated events in platelets.

Exemplary calpain inhibitors include, but are not limited to PD150606 ((Z)-3-(4-iodophenyl)-2-mercapto-2-propenoic acid), PD151746 (3-(5-Fluoro-3-indolyl)-2-mercapto-(Z)-2-propenoic acid), calpastatin, calpeptin, ABT-099, A-965431, A-705253, A-705239, MDL28170 (N—[N-[(phenylmethoxy)carbonyl]-L-valyl]phenylalaninal), Z-LLY-fmk, Z-VAD-fmk (benzyloxycarbonyl-Val-Ala-Asp(OMe)-fluoromethylketone), ALLN (N-Acetyl-L-leucyl-L-leucyl-L-norleucinal).

In another embodiment, the PSL inhibitor includes one or more cyclophilin D inhibitors. Located in the mitochondrial matrix, cyclophilin D modulates the activity of mitochondrial permeability transition pore (MPTP) and is a principal regulator of mitochondrial permeability transition pore (MPTP)-dependent programmed necrosis or Ca²⁺- and oxidative damage-induced cell death. Cyclophilin D inhibitors are also known to inhibit constituents of the mitochondrial respiratory chain, inhibit MPTP formation, inhibit H₂O₂-induced JNK and Akt activation and preserve mitochondrial function. Exemplary cyclophilin D inhibitors include, but are not limited to cyclosporin A, rotenone and oligomycin.

In another embodiment, the PSL inhibitor includes one or more p38 mitogen-activated kinase (MAPK) inhibitors. p38 MAPK signaling is known to down-regulate expression of platelet surface receptors, including GPIb-α and GPV, promote platelet apoptosis and improve posttransfusion survival and hemostatic platelet function. Exemplary p38-MAPK inhibitors include, but are not limited to SB203580 (4-(4-(4-fluorophenyl)-2-(4-(methylsulfinyl)phenyl)-1H-imidazol-5-yl)pyridine), IC₅₀=0.3 μM-0.5 μM; SB202190 (4-(4-(4-fluorophenyl)-5-(pyridin-4-yl)-1H-imidazol-2-yl)phenol), which targets the p38a and p38β isoforms with an IC₅₀ of 50 nM and 100 nM, respectively; VX-702 (1-(5-carbamoyl-6-(2,4-difluorophenyl)pyridin-2-yl)-1-(2,6-difluorophenyl)urea), IC₅₀=4-20 nM) and Skepinone-L ((R)-2-((2,4-difluorophenyl)amino)-7-(2,3-dihydroxypropoxy)-10,11-dihydro-5H-dibenzo[a,d][7]annulen-5-one); IC50=5 nM). In certain embodiments, Skepinone-L may be used at a concentration of 0.05 μm to 20 μm, preferably at a concentration of 0.5 μm to 2 μm.

In another embodiment, the PSL inhibitor includes one or more inhibitors of the phosphoinositide-3-kinase/Akt signaling pathway. Members of the this pathway play an important role in platelet activation, platelet adhesion, spreading, aggregation and thrombosis. They include phosphoinositide 3-kinease (PI3K); phosphoinositide-dependent protein kinase 1 (PDK1), a cytoplasmic membrane-associated enzyme activated by PI3K; Akt isoforms, Akt1, Akt2 and Akt3, which are serine-threonine protein kinases activated by PDK1; and glycogen synthase kinase (GSK-3β), whose kinase activity is inhibited by Akt phosphorylation.

Exemplary PI3K inhibitors include the pan-PI3K inhibitor LY294002 (2-Morpholin-4-yl-8-phenylchromen-4-one, IC₅₀=0.5 μM for PI3Kα, 0.57 μM for PI3Kδ and 0.97 μM for PI3Kβ). In certain embodiments, LY294002 may be used at a concentration between 5-100 μM, preferably 40-60 μM.

Exemplary PDK1 inhibitors include GSK 2334470 ((3S,6R)-1-[6-(3-Amino-1H-indazol-6-yl)-2-(methylamino)-4-pyrimidinyl]-N-cyclohexyl-6-methyl-3-piperidinecarboxamide), IC₅₀˜10 nM); BX912 (N-(3-(4-(2-(1H-imidazol-5-yl)ethylamino)-5-bromopyrimidin-2-ylamino)phenyl)pyrrolidine-1-carboxamide), IC₅₀=12 nM; and BX-795 (N-[3-[[5-Iodo-4-[[3-[(2-thienylcarbonyl)amino]propyl]amino]-2-pyrimidinyl]amino]phenyl]-1-pyrrolidinecarboxamide), IC₅₀=6 nM).

Exemplary Akt inhibitors include, but are not limited to the highly specific pan-Akt inhibitor MK-2206 (CAS 1032350-13-2, IC₅₀=8 nM for Akt1; 12 nM for Akt2; and 65 nM for Akt3; the pan-Akt inhibitor GSK 690693 (4-[2-(4-Amino-1,2,5-oxadiazol-3-yl)-1-ethyl-7-[(3S)-3-piperidinylmethoxy)-1H-imidazo[4,5-c]pyridin-4-yl]-2-methyl-3-butyn-2-ol, IC₅₀=2 nM for Akt1; 13 nM for Akt2; and 9 nM for Akt3).

Exemplary GSK-3β inhibitors include, but are not limited to SB216763 (3-(2,4-(Dichlorophenyl)-4-(1-methyl-1H-indol-3-yl)-1H-pyrrole-2,5-dione, IC₅₀=33.4 nM); TWS119 (3-(6-(3-aminophenyl)-7H-pyrrolo[2,3-d]pyrimidin-4-yloxy)phenol), IC₅₀=30 nM) and CHIR-98014, a GSK-3a/(3 inhibitor (N2-(2-(4-(2,4-dichlorophenyl)-5-(1H-imidazol-1-yl)pyrimidin-2-ylamino)ethyl)-5-nitropyridine-2,6-diamine), IC₅₀=0.58 nM for GSK-3β and 0.65 nM for GSK-3α.

In another embodiment, the PSL inhibitor includes one or more chloride channel inhibitors. PSL is characterized by increased phosphatidylserine (PS) exposure, a signal for triggering cell death. PS exposure is known to be regulated by the Ano6, encoded by the TMEM16F gene. Ano6 acts as a chloride channel regulated by Ca²⁺ or cell volume. Preferably the chloride channel blocker reduces PS exposure. In certain preferred embodiments, the chloride channel blocker is active against a Ca2+ regulated chloride channel, such Ano6. Exemplary chloride channel inhibitors for use in the present invention include, but are not limited to CaCCinh-A01 (6-(1,1-Dimethylethyl)-2[(2-furanylcarbonyl)amino]-4,5,6,7-tetrahydrobenzo[b]thiophene-3-carboxylic acid), T16Ainh-A01 (2-[(5-Ethyl-1,6-dihydro-4-methyl-6-oxo-2-pyrimidinyl)thio]-N-[4-(4-methoxyphenyl)-2-thiazolyl]acetamide) and NPPB (5-Nitro-2-(3-phenylpropylamino)benzoic acid (IC₅₀=0.1-100 μM, depending on channel subtype and assay method).

In another embodiment, the PSL inhibitor is a calcium modulating agent. Like the chloride channel inhibitors described above, calcium modulating agents may be included in the preservation composition to reduce PS exposure. Calcium modulating agents may include intracellular calcium modulating agents, extracellular calcium modulating agents or combinations thereof. These agents may be included at a concentration sufficient for reducing or neutralizing intracellular and/or extracellular Ca²⁺. An intracellular calcium modulating agent may be employed to decrease intracellular platelet calcium concentrations, using e.g., a calcium channel inhibitor, permeant calcium chelator or both. An extracellular calcium modulating agent may be employed to decrease extracellular concentrations of calcium in the platelet medium using e.g., a calcium sequestration agent or a calcium chelator.

Intracellular calcium modulating agents are well-known in the field. By way of example, hypocalcemia-inducing agents may be chosen among biphosphonates, calcimimetic agents or calcitonine. Among the biphosphonates, palmidronate, zoledronate, etidronate, ibandronate or clodronate may be employed. Calcimimetic agents include, for example cinacalcet. Calcium channel inhibitors are also well known in the field, and may be for example 2-Aminoethoxydiphenyl borate (2-APB), ML-9 or BTP-2.

Calcium sequestration agents or chelators include BAPTA (1,2-bis(o-amino phenoxy)ethane-N,N,N′,N′-tetraacetic acid), EGTA (glycol-bis(2-aminoethylether)-N,N,N′,N′-tetraacetic acid), EDTA (2-[2-(bis(carboxymethyl)amino)ethyl-(carboxymethyl)amino]acetic acid) and CDTA (trans-1,2-cyclohexane diamine-tetraacetic acid) which are non-permeant agents, along with their corresponding permeant forms, BAPTA-AM (1,2-bis-(o-amino phenoxy)ethane-N,N,N′,N′-tetraacetic tetra-(acetoxymethyl) acid ester), derivatives of BAPTA-AM such as 5,5′-difluoro-BAPTA-AM (5,5′ F2 BAPTA), or 5-5′-dimethyl-BAPTA-AM, EGTA-AM, EDTA-AM and CDTA-AM. BAPTA-AM ([1,2-bis-(o-aminophenoxy)ethane-N,N,N′,N′-tetraacetic acid tetra-(acetoxymethyl)ester]) is a cell permeable compound not being able in its present form to chelate Ca²⁺. However, once inside the cell, BAPTA-AM molecules are hydrolyzed by ubiquitous intracellular esterases, releasing a cell membrane impermeable Ca²⁺ chelator. Contrary to BAPTA-AM which specifically traps intracellular free calcium, unmodified non permeant BAPTA or EGTA chelates preferentially the extracellular free calcium.

Other calcium sequestration agents include, but are not limited to, anticoagulant citrate dextrose solution, anticoagulant citrate dextrose solution modified, anticoagulant citrate phosphate dextrose solution, anticoagulant sodium citrate solution, anticoagulant citrate phosphate dextrose adenine solution, potassium oxalate, sodium citrate, sodium oxalate, amlodipine, bepridil hydrochloride, diltiazem hydrochloride, felodipine, isradipine, nicardipine hydrochloride, nifedipine, nimodipine, verapamil hydrochloride, doxazocin mesylate, phenoxybenzamine hydrochloride, phentolamine mesylate, prazosin hydrochloride, terazosin hydrochloride, tolazoline hydrochloride, acebutolol hydrochloride, atenolol, betaxolol hydrochloride, bisoprolol fumarate, carteolol hydrochloride, esmolol hydrochloride, indoramine hydrochloride, labetalol hydrochloride, levobunolol hydrochloride, metipranolol hydrochloride, metoprolol tartrate, nadolol, penbutolol sulfate, pindolol, propranolol hydrochloride, terazosin hydrochloride, timolol maleate, guanadrel sulfate, guanethidine monosulfate, metyrosine, reserpine and mixtures thereof.

Alternatively, or in addition, the platelet preservation composition may be prepared in a Ca²⁺-free formulation.

In another embodiment, the PSL inhibitor includes one or more caspase inhibitors. Caspases are principal mediators of apoptosis. The caspase inhibitor may be reversible or irreversible. Exemplary caspase inhibitors include the cell-permeable, irreversible inhibitor of caspase-3/CPP32, Z-DEVD-fmk (benzyloxycarbonyl-Asp(OMe)-Glu(OMe)-Val-Asp(OMe)-fluoromethylketone), IC₅₀=130 nM); the reversible, cell-permeable inhibitor of caspase-3, Ivachtin (2-[4-Methyl-8-(morpholin-4-ylsulfonyl)-1,3-dioxo-1,3-dihydro-2H-pyrrolo[3,4-c]quinolin-2-yl]ethyl acetate), IC₅₀=23 nM; the selective non-peptide inhibitor of caspase-3, AZ 10417808 (2-[(3,4-dichlorophenyl)amino]-1,4-dihydro-6-nitro-4-oxo-N-2-propenyl-8-quinazolinecarboxamide), Kᵢ=247 nM); and the cell-permeable, irreversible pan-caspase inhibitor, Z-VAD-fmk (benzyloxycarbonyl-Val-Ala-Asp(OMe)-fluoromethylketone). Z-VAD-fmk may be used at concentrations between 10 μM and 10 mM.

In another embodiment, the PSL inhibitor includes one or more protein synthesis inhibitors. In spite of its anuclear nature, platelets are known to exhibit signal-dependent translation during activation. Accordingly, protein synthesis inhibitors may be employed to inhibit platelet activation. Exemplary reversible protein synthesis inhibitors include deuterated benzaldehyde derivative, zilascorb(2H)(5,6-O-benzylidene-d-L-ascorbic acid), anisomycin (2-[methoxybenzyl]-3,4,pyrrolidinediol 3-aceate), emetine and rapamycin.

In another embodiment, the PSL inhibitor includes one or more sialidase inhibitors. Desialylation of platelet von Willebrand factor receptor (VWFR) is known to trigger platelet clearance and primes GPIb and GPV for metalloproteinase-dependent cleavage. Exemplary sialidase inhibitors include, but are not limited to 2,3-dehydro-2-deoxy-N-acetylneuraminic acid (DANA), ethyl (3R,4R,5S)-5-amino-4-acetamido-3-(pentan-3-yloxy)-cyclohex-1-ene-1-carboxylate), (2R,3R,4S)-4-guanidino-3-(prop-1-en-2-ylamino)-2-((1R,2R)-1,2,3-trihydroxypropyl)-3,4-dihydro-2H-pyran-6-carboxylic acid, (4S,5R,6R)-5-acetamido-4-carbamimidamido-6-[(1R,2R)-3-hydroxy-2-methoxypropyl]-5,6-dihydro-4H-pyran-2-carboxylic acid, (1S,2S,3S,4R)-3-[(1S)-1-acetamido-2-ethyl-butyl]-4-(diaminomethylideneamino)-2-hydroxy-cyclopentane-1-carboxylic acid, ADDN (Neu5Ac2en, N-Acetyl-2,3-dehydro-2-deoxyneuraminic acid), 4-amino-Neu5Ac2en (5-acetylamino-2,6-anhydro-4-amino-3,4,5-trideoxy-D-glycerol-D-galacto-no-n-2-enoic acid), 4-guanidino-NeuSAc2en (5-acetylamino-2,6-anhydro-4-guanidino-3,4,5-trideoxy-D-glycerol-D-galact-o-non-2-enoic acid), fetuin, oseltamivir, zanamivir, laninamivir, peramivir and pharmaceutically acceptable salts thereof.

Other Additives

Other additives, including the glycolytic inhibitor 2-deoxy-D-glucose, may also be used with the platelet preservation composition of this invention. In platelets, 2-deoxy-D-glucose slows down the rate of glycolysis by competing with glucose for enzymes utilized in the glycolysis pathway. 2-deoxy-D-glucose is phosphorylated by the same enzymes which phosphorylate glucose, but at a slower rate than that of glucose phosphorylation. Such competitive binding slows the rate of glucose breakdown by the cell and consequently slows the rate of lactic acid production by platelets during storage. Such an additive may help contribute to platelet viability during and after microbe inactivation. 2-deoxy-D-glucose may be added to the platelet preservation composition at a concentration of about 10 mM.

Platelet Preservation Formulations

A preservation composition of the present invention may be used in an amount from about 5 to 10 mL for about one unit of platelets (typically a platelet unit is between 250 and 300 mL). Alternatively, 5 to 10 mL of the preservation composition of the present invention may be combined to obtain between 15 to 30% of the optimum concentration of the inhibitors used for a unit of platelets. Typically, platelets derived from whole blood, require a pooling of 4 to 6 units of whole blood to obtain a therapeutic platelet unit.

In one embodiment, the preservation composition contains a photosensitizer and an inhibitor of platelet activation dissolved in about 45 to about 55 ml of an oxygen carrier. In a preferred embodiment, the preservation composition comprises eptifibatide and argatroban. When used with a unit of whole blood, the inhibitor of platelet activation can also be dissolved in about 45 to about 55 ml of normal saline to preserve the freshness of the platelets without an oxygen carrier.

Platelet preservation agents are added in amounts or concentration effective for reducing one or more characteristics of PSL. The amounts or concentrations of the preservation agents present in the preservation composition depend on the preservation agent. For example, the amount of the platelet activation inhibitor should be sufficient to reversibly inhibit binding to a ligand or site on the platelet in a manner that is sufficient to inhibit platelet function. For GPIIb/IIIa inhibitors, such as eptifibatide, suitable amounts in the preservation composition may range from about 0.5 mg to about 3 mg for 50 ml of acellular hemoglobin-based oxygen carrier substantially free of red cell membrane (stroma) contaminants. NSAIDs, for example, ibuprofen, may be preferably present in the preservation composition in an amount from about 20 mg to about 60 mg for each 50 ml of acellular hemoglobin-based oxygen carrier that is substantially free of red cell membrane contaminants.

The use of short-to-ultra-short acting platelet activation inhibitor, and short-to-ultra-short anticoagulant can reduce the potentially adverse effects of any leftover preservation agents in the preserved platelets.

The term “pharmaceutically acceptable” as used herein refers to a substance that complies with the regulations enforced by the FDA regarding the safety of use in a human or animal subject or a substance that has passed FDA human safety trials. The term “pharmaceutically acceptable platelet activation inhibitor”, for example, refers to an active agent that prevents, inhibits, or suppresses platelet adherence and/or aggregation, and comports with guidelines for pharmaceutical use as set forth by the FDA.

Platelet preservation agents of the present invention may be present in preservation compositions at a concentrations between 1 nM and 100 mM, between 10 nM and 100 mM, between 100 nM and 100 mM, between 1 μm and 100 mM, between 10 μm and 100 mM, between 100 μm and 100 mM, between 1 mM and 100 mM, between 10 mM and 100 mM, between 1 nM and 10 mM, between 10 nM and 10 mM, between 100 nM and 10 mM, between 1 μm and 10 mM, between 10 μm and 10 mM, between 100 μm and 10 mM, between 1 mM and 10 mM, between 1 nM and 1 mM, between 10 nM and 1 mM, between 100 nM and 1 mM, between 1 μm and 1 mM, between 10 μm and 1 mM, between 100 μm and 1 mM, between 1 nM and 100 μm, between 10 nM and 100 μm, between 100 nM and 100 μm, between 1 μm and 100 μm, between 10 μm and 100 μm, between 1 nM and 10 μm, between 10 nM and 10 μm, between 100 nM and 10 μm, between 1 μm and 10 μm, between 1 nM and 1 μm, between 10 nM and 1 μm, between 100 nM and 1 μm, between 1 μm and 10 μm, between 1 nM and 100 nm, between 10 nM and 100 nm or between 1 nM and 10 nm.

IC₅₀ is a measure of the effectiveness of a substance in inhibiting a specific biological or biochemical function and is commonly used as a measure of antagonist drug potency. The IC₅₀ value indicates how much of a particular drug or other substance (inhibitor) is needed to inhibit a given biological process (or component of a process, i.e., an enzyme, cell, cell receptor or microorganism) by 50%.

A platelet preservation agent may be present in the platelet preservation composition or preserved platelet preparation at a concentration between 10-fold the concentration of the IC₅₀ of the inhibitor (e.g., as cited above) and a concentration 50-fold, 100-fold, 1000-fold, 5.000-fold, 10.000-fold, 50.000-fold or 100.000-fold greater than the IC₅₀ (and any ranges therebetween).

The preservation composition can be stored at room temperature or low temperature as further described below. Platelet function also can be better maintained throughout the 5-day storage period mandated by the FDA, or longer. The preservation composition can extend to 5-day storage period and maintain the shelf-life of the platelets suitable for transfusion for at least 6 days, at least 7 days, at least 8 days, at least 9 days, at least 10 days, at least 11 days, at least 12 days, at least 13 days or at least 2 weeks post-collection. As used herein, the phrase “maintaining the shelf-life” refers to a maintenance of platelet quality according to FDA standards known to those of skill in the art. Platelet quality is assessed most importantly by the pH of the medium. A pH below 6.8 usually leads to poor platelet functionality and significant platelet apoptosis. This results from the consumption of glucose in the medium and the generation of lactic acid from anaerobic metabolism. Measurement of the enzyme, lactic dehydrogenase, an intracellular enzyme is a good indicator of cell death. Assays for platelet functionality include, but are not limited to, evaluation of platelet morphology, extent of shape change (ESC), hypotonic shock response (HSR), thromboelastography, response to agonists (e.g., ADP, collagen), in vivo 24 hr CCI (corrected count increment), etc. The 24 hour corrected count increment is a measure of platelet transfusion recovery. Typically test platelets are radiolabelled along with control platelets from the same split unit but a different radiolabel. This allows for the counting of the labelled platelets in circulation at different time points up to 24 hours. The corrected count increment (CCI) is calculated as:

CCI=(platelet increment per μL)×(body surface area in m²)×10¹¹/number of platelets transfused

For example, a 70 kg patient has a body surface area of 1.8 m2, a pre-transfusion platelet count of 5,000/μL, and is transfused with an apheresis platelet unit containing 3.2×10¹¹ platelets. The post transfusion platelet count is 30,000/μL. The CCI would be calculated as follows:

$$CCI = \frac{1.8 {m}^{2} \times ( 30 , 000 \text{/} µL - 5 , 000 \text{/} µL ) \times {10}^{11}}{3.2 \times {10}^{11}}$$

$$CCI = 14 , 000 platelet \times {m}^{2} \text{/} µL$$

In certain embodiments, the preservation composition is capable of reducing the expression of P-selectin (CD62P) or soluble glycoprotein V (sGPV), reducing the release of alpha granules, reducing apoptosis-specific morphologic or biochemical changes reducing platelet surface expression of phosphatidylserine and/or reducing the formation of micro aggregates by at least 10%, 20%, 50%, 70%, 90% or 100% relative to a control preservation composition lacking one or more antiplatelet agents, anticoagulants, oxygen carriers and/or PSL agents or of reducing any one or more these changes by at least 2-fold, 5-fold, 10-fold or 100-fold relative to a control.

In other embodiments, the preservation composition is capable of increasing signaling responses, platelet activation, secretion or aggregation in response to agonists; increasing the response to in vitro challenge tests, such as the hypotonic shock response (HSR); and/or increasing in vivo recovery or survival of the treated platelets in the preserved platelet preparation by at least 10%, 20%, 50%, 70%, 90% or 100% relative to a control preservation composition lacking one or more antiplatelet agents, anticoagulants, oxygen carriers and/or PSL agents or of increasing the level of any one or more these changes by at least 2-fold, 5-fold, 10-fold or 100-fold relative to a control platelet preparation.

Preserved Platelet Preparations

Another aspect of the present invention relates to a preserved platelet preparation, comprising an irradiated platelet preparation, an effective amount photosensitizer and effective amounts of one or more platelet preservation agents. The preserved platelet composition may include any of the above-described preservation compositions.

In one embodiment, the preserved platelet preparation includes an irradiated platelet preparation, a platelet activation inhibitor and an anticoagulant. Alternatively, or in addition, the preserved platelet preparation includes an irradiated platelet preparation and one or more PSL inhibitors selected from the group consisting of mitochondrial-targeted antioxidant, calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof, wherein the PSL inhibitor is present in an amount effective to reduce or prevent one or more changes characteristic of platelet storage lesion.

The terms “effective amount” and “amount effective” as used herein, refers to an amount effective, at dosages and for periods of time necessary, to achieve the desired result, e.g., sufficient to inactivate microbes in the platelet preparation, inactivate platelets in a platelet preparation, reduce/prevent activation of platelets in a platelet preparation or reduce/prevent one or more changes characteristic of platelet storage lesion.

The photosensitizers and other preservation agents may be removed prior to transfusion in order to reduce any potentially toxic or adverse effects as further described below. Preferably, the platelets are substantially free of activated platelets both prior to and following treatment of the platelet compositions with the photosensitizers and preservation agents of the present invention. Platelet sources and methods of making the same are further described below.

The treated platelets in the preserved preservation preparation may be characterized by an increased shelf-life for transfusion of at least 6 days, at least 7 days, at least 8 days, at least 9 days, at least 10 days, at least 11 days, at least 12 days, at least 13 days or at least 2 weeks post-collection. In addition, the preserved platelet preparation is capable of maintaining the pH between 6.8 to 7.6 for the duration of its shelf-life. In certain particular embodiments, the preserved platelet preparation is capable of maintaining the pH in the preserved platelet preparation above 6.0 or above 6.5, above, above 6.8, above 6.9, above 7.0, above 7.1, above 7.2, above 7.3, above 7.4 or above 7.5. Additionally, use of the preserved platelet compositions in combination with the pathogen inactivation methodologies described herein can allow for little (<10% reduction) or no reduction in platelet counts upon storage.

Platelet preservation compositions and preserved platelet compositions of the present invention may be stored in a range of temperatures between about −80° C. to about 42° C. As used herein, the term “room temperature” or “ambient temperature” refers to a temperature in the range of 12° C. to 30° C.; the term “body temperature” refers to a temperature in the range of 35° C. to 42° C.; the term “refrigeration temperature” refers to a temperature in the range of 0° C. to 12° C.; and the term “freezing temperature” refers to a temperature below 0° C. The term “cold storage” or “storage at low temperature” refers to storage at −20° C. to 12° C., preferably 2° C. to 12° C., more preferably 4° C. to 8° C.

Method for Extending Shelf-Life of Platelets

One aspect of the present invention relates to a method preserving and/or extending the shelf-life of platelets. In one embodiment, the method for preserving platelets, comprises irradiating a platelet mixture having an effective amount of a photosensitizer under conditions sufficient to activate the photosensitizer and inactivate microbes in the platelet mixture to form a microbe-depleted platelet preparation. Following irradiation, at least one platelet activation inhibitor and at least one anticoagulant are added to the microbe-depleted platelet preparation in amounts effective to form a platelet preservation composition.

A plurality of platelet preservation agents may be added to the platelet mixture, the microbe-depleted platelet preparation, or both. Thus, the platelet preservation agents may be present in a platelet preparation before and/or after the irradiation of the platelets in the presence of the photosensitizer. Platelet preservation agents are added to preserve the activity and/or extend the shelf-life of the platelets. Exemplary platelet preservation agents include, but are not limited to, platelet activation inhibitors, anticoagulants, oxygen carriers, non-steroidal anti-inflammatory drugs, anti-microbial agents, quenchers, and other additives.

Platelet preservation agents may include any additives or inhibitors capable of preserving the activity and/or extending the shelf-life of platelets. Exemplary platelet preservation agents for use in the present invention include, but are not limited to platelet activation inhibitors, anticoagulants, oxygen carriers, protein synthesis inhibitors, cyclophilin D inhibitors, p38-MAPK inhibitors, calpain inhibitors, mitochondrial-targeted antioxidants, GSK-3β inhibitors, sialidase inhibitors, non-steroidal anti-inflammatory drugs, anti-microbial agents, quenchers, other additives and any combinations thereof.

Preferably the photosensitizer is used in a concentration of at least about 1 μM up to the solubility of the photosensitizer in the fluid. In one embodiment, the photosensitizer is riboflavin and is used at a concentration range between about 1 μM and about 160 μM, preferably about 50 μM. In one embodiment, the photosensitizer is added directly to the platelets.

The platelet mixture containing the photosensitizer is exposed to photoradiation of a defined wavelength for a time sufficient to reduce any microbes which may be contained in the preservation composition. The wavelength used will depend on the type of photosensitizer selected such that the light source may provide light of about 270 nm to about 700 nm. The use of ultraviolet radiation in the UVA (320-400 nm) and UVB (280-320) ranges or visible light (e.g., 590 nm) allow for the ability to inactivate microbes via DNA damage.

The light source may be a simple lamp, or may consist of multiple lamps radiating at different wavelengths. The photoradiation source should be capable of delivering from about 0.01 J/cm² to about 200 J/cm². The illumination time varies based upon the type of photosensitizer, but is typically in the range of 30 seconds to 30 minutes.

In certain embodiments, the photoradiation source is a monochromatic radiation. The source can have wavelengths in the range of 200 to 400 nm, 250 to 308 nm, or alternatively in the visible range. Exposure of platelets, plasma or other cellular components of blood, in a highly UV transmissible container, allows exposure to monochromatic radiation between 3 and 10 Joules/cm², from above and below. This treatment reduces microbe levels by 4 to 7 logs.

Irradiating the preservation composition in the presence of photosensitizers may cause the degradation of preservation agents, including the platelet activation inhibitors and/or anticoagulants, as further described below. Accordingly, the preservation agents may be added at higher concentrations to compensate for this loss in activity, and e.g., retain inhibitory activity in the preservation composition during and after the irradiation (or illumination) step. Alternatively, or in addition, preservation agents, including platelet activation inhibitors, may be additionally supplemented following the irradiation step. In one embodiment, platelet activation inhibitor(s) are added at 2-3 times their therapeutic concentration or more. By way of example, in one embodiment, eptifibatide and argatroban may be added to platelets at three times their therapeutic concentration.

Inhibitors of platelet activation and anticoagulants may be present in the preservation composition (or added thereto) prior to and/or following the illumination step. Additional preservation agents, including oxygen carriers, NSAID drugs, and/or anti-microbial agents may be similarly present in the preservation composition (or added thereto) prior to and/or following the illumination step. Preferably, the admixed platelets are substantially free of activated platelets prior to addition of the inhibitor(s) of platelet activation.

Preservation agents, including inhibitors of platelet activation and anticoagulants may be added to the platelets separately from the photosensitizer or they can be added together.

In one embodiment, the platelets to be decontaminated to which the photosensitizer and the platelet activation inhibitor is flowed past a photoradiation source such that the flow of the material generally provides sufficient turbulence to distribute the photosensitizer and platelet activation inhibitor throughout the fluid to be microbe reduced. A separate mixing step may optionally be included.

In another embodiment, the preservation composition, including the photosensitizer and the inhibitor(s) of platelet activation are placed in a photopermeable bag container and irradiated in batch mode, preferably while agitating the container to fully distribute the photosensitizer throughout the fluid and expose all the fluid to the radiation. Platelet activation inhibitors may be added to the preservation composition either before irradiation, during irradiation, after irradiation, or combinations thereof.

In one embodiment, the photopermeable container is a bag (such as a blood bag) made of transparent or semitransparent plastic, and the agitating means preferably includes a mechanism for shaking the bag or container in multiple planes. Further, the container or bag may be oxygen-permeable or oxygen-impermeable. The bag or platelet storage bag can contain between about 50 ml (pediatric unit) to about 450 ml of platelet concentrate. The platelet concentrations in the storage can range between 10⁷-10¹¹ platelets/ml, 10⁸-10¹¹ platelets/ml or 10⁹-10¹⁰ platelets/ml. In one embodiment, the bag contains about 300 ml of platelet at a concentration of about 10⁹-10¹° platelets/ml with about 48 μg eptifibatide and 2.5 mg argatroban.

Prior to the clinical use of the preserved platelets, photosensitizers and/or preservation agents, including inhibitors of platelet activation and/or anticoagulants may be removed or inactivated, thereby eliminating any concerns of adverse or toxic effects from the photosensitizers, platelet preservation agents, or other plasma components prior to transfusion.

When endogenous photosensitizers are used, particularly when such photosensitizers are not inherently toxic or do not yield toxic photoproducts after photoradiation, it may be unnecessary to remove the photosensitizer prior to transfusion of the treated platelets. When using photosensitizers that are toxic or yield toxic photoproducts, however, the toxic products may be removed by diafiltration or other suitable removal means, including those as further described below.

Given that preservation agents may be susceptible to degradation following irradiation, an additional irradiation step may be employed immediately prior to transfusion to inactivate the preservation agents, such as inhibitors of platelet activation and/or anticoagulants. In one embodiment, freshly prepared photosensitizer(s), preferably endogenous photosensitizer(s), are added to the platelet mixture just prior to irradiation for this purpose. Depending on the selection of the preservation agents, this additional irradiation step may provide an alternative to other removal means, including diafiltration as further described below.

Removal of Photosensitizers and/or Active Agents

Prior to the clinical use (or transfusion) of the preserved platelets, photosensitizers, as well as the platelet preservation agents, should be removed to eliminate potential adverse effects therefrom. Accordingly, another aspect of the present application relates a method for removing the photosensitizers and/or preservation agents from a preserved platelet preparation.

In one embodiment, the photosensitizers are removed by passage through a compound adsorption device (CAD) as in the INTERCEPT Blood System for removal of amotosalen. Alternatively, or in addition, the platelet preservation agents may be similarly removed with a compound adsorption device specifically designed therefor. Photosensitizers and/or platelet preservation agents may be removed by passing the preserved platelet preparation through a CAD device over a period of 4-16 hours.

In another embodiment, the photosensitizers and/or platelet preservation agents are removed from a platelet preparation by tangential flow filtration (TFF).

Tangential Flow Filtration (TFF)

Filtration is a pressure driven separation process that uses membranes (or filters) to separate components in a liquid solution or suspension based on their size differences. Filtration can be broken down into two different operational modes-normal flow filtration (NFF) and tangential flow filtration (TFF). In NFF, fluid is connected directly toward the membrane under an applied pressure. Particulates that are too large to pass through the pores of the membrane accumulate at the membrane surface or in the depth of the filtration media, while smaller molecules pass through to the downstream side. This type of process is also called dead-end filtration.

In TFF, the fluid is pumped tangentially along the surface of the membrane. An applied pressure serves to force a portion of the fluid through the membrane to the filtrate side. As in NFF, particulates and macromolecules that are too large to pass through the membrane pores are retained on the upstream side. However, in this case the retained components do not build up at the surface of the membrane. Instead, they are swept along by the tangential flow. This feature of TFF makes it an ideal process for finer sized-based separations. TFF is also commonly called cross-flow filtration. However, the term “tangential” is descriptive of the direction of fluid flow relative to the membrane.

Diafiltration is a TFF method of “washing” or removing permeable molecules (impurities, salts, solvents, small proteins, etc) from a solution, including antibodies from plasma which are associated with transfusion related acute lung injury. Because it is a significantly faster and scalable method, diafiltration frequently replaces membrane tube dialysis. The success of diafiltration is largely determined by the selection of an appropriate membrane. The membrane pores must be large enough to allow the permeable species to pass through and small enough to retain the larger species. A rule of thumb in selecting the membrane is to choose a membrane whose pore size is rated 2-5 times smaller than anything to be retained, and 2-5 times larger than anything to be removed by the filtration. A large variety of pore sizes are available in the ultrafiltration and micro filtration range for this purpose.

In one embodiment, the photosensitizers and/or preservation agents are removed from the platelet preparation by diafiltration, wherein a diafiltration buffer is added to the platelet preparation during circulation to maintain a constant volume of the platelet preparation. In a preferred embodiment, the photosensitizers are removed by diafiltration with 4-6 volume exchange with a diafiltration buffer. The buffer can be a physiologic saline solution (0.9% sodium chloride), or any other platelet storage solution, such as Intersol.

In certain embodiments up to 5% albumin or 20 to 35% plasma (v/v) may be added to the preserved platelet preparation. In this case, the photosensitizers and other platelet preservation agents are removed by diafiltration with 4-6 volume exchange, 6-10 volume exchange, or 10-15 volume exchange with a diafiltration buffer (e.g., 0.9% sodium chloride or any suitable platelet storage solution such as Intersol) containing no plasma.

In one embodiment, an extraction liquid is circulated outside the filtering tube in a counter current manner to facilitate the filtration process. In a related embodiment, the extraction fluid comprises 0.9% w/v sodium chloride.

In one embodiment, a continuous diafiltration system is employed wherein the diafiltration buffer is automatically added to the process reservoir by vacuum suction. Such a system can include a pump, pressure measurement device, flow measurement device, process reservoir, buffer reservoir, and hollow fiber filter module. The pump circulates the process solution from the process reservoir, through the filter and back to the process vessel at a controlled flow and shear rate. Pressure measurements are acquired in this re-circulation loop to control and record the driving force through the membrane. Careful measurement of the permeate flow rate enables accurate process scale up and process optimization. Diafiltration occurs simply by adding the diafiltration buffer to this circulation loop. Working with a hollow fiber module, tubing and an air-tight sealable bottle is a simple means of performing a continuous diafiltration.

To begin the diafiltration in an airtight system, a vacuum needs to be created in the process vessel. This can be accomplished by submerging the buffer addition tube into a bottle of diafiltration buffer. As permeate flows out of the system, the vacuum in the sealed process reservoir pulls buffer into it at a flow rate equal to the process flux. When the target volume of diafiltration buffer has been collected in the permeate vessel, the process is stopped simply by stopping the permeate flow and breaking the vacuum seal on the feed reservoir.

When airtight systems are not possible, particularly for pilot and manufacturing scale processes, buffer addition can be controlled to match the permeate flow rate through the use of a single- or double-headed secondary pump adding buffer into the feed or process reservoir. Sometimes, it is advantageous to reduce the process volume by concentration before diafiltration. There is a relationship between the volume of buffer required to remove a permeable species and the product solution volume in the process reservoir. By understanding this relationship, the cost associated with the process time and the volume of buffer can be minimized.

In a preferred embodiment, the removal of the photosensitizers and platelet preservation agents by TFF involves the use of micro filtration membranes. Microfiltration membrane materials include, but are not limited to, regenerated cellulose, cellulose acetate, polyamide, polyurethane, polypropylene, polysulfone, polyethersulfone, polycarbonate, nylon, polyimide and combinations thereof. In one embodiment, the microfiltration membrane is a hollow fiber membrane made of polysulfone or polyethersulfone. In another embodiment, the filter membrane tubes has inner diameter of 0.5 mm or greater with the membrane pore size of 0.05 micron or larger. In another embodiment, the membrane has a pore size ranging from a molecular weight cut off of 500 daltons to 0.5 micron, from a molecular weight cut off of 500 daltons to 0.2 micron, from a molecular weight cut off of 500 daltons to 0.05 micron, from a molecular weight cut off of 500 daltons to 0.02 micron; or from a molecular weight cut off of 3000 daltons to 0.5 micron, from a molecular weight cut off of 3000 daltons to 0.2 micron, from a molecular weight cut off of 3000 daltons to 0.05 micron, or from a molecular weight cut off of 3000 daltons to 0.02 micron.

In other embodiments, these membranes can be chemically modified to provide a greater positive or negative charge depending on the specific application thereby selectively binding a solute of interest. Alternatively, the surface chemistry of these membranes can be modified to specifically bind solutes of interest such as the antiplatelet agents or direct thrombin inhibitors.

In another embodiment, the platelet preparation is passed through the hollow fiber membrane filter at flow rates ranging from 150 ml/minute to 370 ml/minute. Theses flow rates provide acceptable shear forces from 2000-s to 4000-s. An acceptable pump provides a wide range of flow rates and also provides continuous monitoring of inlet, retentate, permeate and transmembrane pressures. In one embodiment, the pump is the Kros Flow II pump (Spectrum Labs, Rancho Dominguez, Calif.). A replacement fluid suitable for the removal of antiplatelet and anticoagulant agents would be fluids that are used for the storage of platelets. Typically a 10 to 15 volume exchange will result in the removal of better than 99% of the photosensitizer and other added agents.

Typically, a unit of platelets obtained by the buffy coat method may contain about 3×10⁹ platelets in approximately 300 ml of plasma or other suitable preservation composition. A unit of platelets collected by apheresis usually contains about 5×10¹¹ platelets in 250 to 300 ml of plasma or other suitable fluid. Typically, up to 500 micromoles/L of riboflavin (vitamin B2), up to 200 micrograms/L of psoralen dyes, such as amotosalen, 45 to 100 μg of an antiplatelet agent, such as eptifibatide, and 2.5 to 10 mg of anticoagulant, such as argatroban, may be removed from a unit of platelets.

In another embodiment, the preserved platelet preparation is passed through the hollow fiber filter in a diafiltration device at flow rates ranging from 20 to 400 ml/min, preferably 150 to 400 ml/min. The hollow fiber membrane filters with a pore size ranging from molecular weight cut off of 500 daltons to 0.5 micron are acceptable. The preferred pore size is 0.05 micron. For the exchange of one unit of platelets (300 to 400 ml) the preferred surface area of the filtration module is 2500 cm². This setting can allow for the complete removal (>99%) of the photosensitizers, platelet activation inhibitors, anticoagulants, and/or plasma components contained in a unit of platelets in 15 minutes with a flow rate of 370 ml/min. The diafiltration buffer (i.e., replacement fluid) can be any solution suitable for platelet storage. In one embodiment, the diafiltration buffer is a commercially available platelet storage solution (T-Sol) with or without 20% plasma.

In one embodiment, the photosensitizers and/or platelet preservation agents are removed from the preserved platelet preparation by passage through a porous material that specifically binds to one or more of the photosensitizers, platelet preservation agents and/or metabolites therefrom.

In certain embodiments, the porous material comprises a nanofiber. Examples of nanofiber include, but are not limited to, cellulose nanofibers, biodegradable nanofibers and carbon nanofibers.

Cellulose nanofibers may be obtained from various sources such as flax bast fibers, hemp fibers, kraft pulp, and rutabaga, by chemical treatments followed by innovative mechanical techniques. The nanofibers thus obtained have diameters between 5 and 60 nm. The ultrastructure of cellulose nanofibers is investigated by atomic force microscopy and transmission electron microscopy. The cellulose nanofibers are also characterized in terms of crystallinity. In one embodiment, the membrane filter is a reinforced composite film comprising 90% polyvinyl alcohol and 10% nanofibers.

The chemistry of these cellulose fibers can be modified to provide specific binding sites for a given photosensitizer. These fibers can be coated onto the surface of currently available disposable filter platforms like those used for sterilizing small volumes of fluids.

Biodegradable polymers, such as poly(glycolic acid) (PGA), poly(L-lactic acid) (PLLA) and poly(lactic-co-glycolic acid) (PLGA), can be dissolved individually in the proper solvents and then subjected to electrospinning process to make nanofibrous scaffolds. Their surfaces can then be chemically modified using oxygen plasma treatment and in situ grafting of hydrophilic acrylic acid (AA). In one embodiment, the biodegradable nanofibrous scaffold has a fiber thickness in the range of 200-800 nm, a pore size in the range of 2-30 micron, and porosity in the range of 94-96%.

The ultimate tensile strength of PGA will be about 2.5 MPa on average and that of PLGA and PLLA will be less than 2 MPa. The elongation-at-break will be 100-130% for the three nanofibrous scaffolds. When the surface properties of AA-grafted scaffolds are examined, higher ratios of oxygen to carbon, lower contact angles and the presence of carboxylic (—COOH) groups are identified. With the use of plasma treatment and AA grafting, the hydrophilic functional groups can be successfully adapted on the surface of electrospun nanofibrous scaffolds. These surface-modified scaffolds provide the necessary sites for adding ligands specific to the binding of a given preservative composition agent.

There are several approaches that can be utilized to convert activated carbon into bioreactive fibers. An example is provided to demonstrate the ability of these modified carbon nanofibers to provide carboxylic, hydroxyl and other chemically reactive sites for the binding of any ligand of interest.

Carbon nanofibers (CNF) can be synthesized by chemical vapor deposition (CVD). Amino acids, such as alanine, aspartic acid, glutamic acid and enzymes such as glucose oxidase (GOx) can be adsorbed on CNF. The properties of CNF (hydrophilic or hydrophobic) are characterized by the pH value, the concentration of acidic/basic sites and by naphthalene adsorption. These fibers are readily amenable to crosslinking with ligands of interest, e.g., the ability to selectively bind to antiplatelet agents, anticoagulants, antibodies, PSL inhibitors, etc.

Photosensitizers and platelet preservation agents may also be removed from a platelet preparation by centrifugation or chromatography. In this case, platelets may be precipitated under conditions that do not precipitate preservation agents. The precipitated platelets are then washed and resuspended for clinical use. Similarly, chromatographic methods such as column chromatography may also be used to separate the platelets from the antiplatelet agent and anticoagulant. Alternatively, the preserved platelet composition agents may be removed from a platelet preparation by affinity-based removal methods such as magnetic beads coated with antibodies that bind to the preserved platelet composition agents.

Platelet Formulations and Sources

Platelets may be derived from whole blood or platelet-containing components of whole blood, or they may be further isolated therefrom. Preferably, the platelets are substantially free of red blood cells and other blood nutrients and/or are substantially free of activated platelets.

Typically, the blood is whole blood isolated from a mammal, for use in the same species. In the case of a human, the blood is isolated and separated into the three core components of whole blood, i.e., plasma, cells, and platelets. The whole blood, or only the platelet component of the whole blood, can be treated with the preservation composition. If whole blood is treated, a preferred embodiment contemplates the use of only some components of the proposed preservation composition, such as the antiplatelet agent and anticoagulant, for whole blood storage. The blood can then be fractionated and the platelet component can be further mixed with the preservation composition of the present invention for storage.

In one embodiment, platelets are derived from a non-plasma blood component. More particularly, blood is passed through a filter comprising a filtering membrane to separate plasma in blood from the non-plasma component by tangential flow filtration, wherein a diafiltration solution is added to the non-plasma blood component to replace some or all of the permeate volume. The diafiltration solution can be a plasma-free solution commonly used for the storage of the non-plasma blood component but without any antiplatelet agent and/or anticoagulant. Examples of the diafiltration solution include, but are not limited to, Intersol (Fenwal), T-Sol, PAS II, PAS IIIM, PAS27 (Baxter). In one embodiment, the diafiltration buffer is a commercially available platelet storage solution (T-Sol). In another embodiment, the diafiltration buffer is a commercially available platelet storage solution (T-Sol) with 20% to 30% plasma. In one embodiment, an extraction liquid is circulated outside the filtering tube in a counter current manner to facilitate the filtration process. In a related embodiment, the extraction fluid comprises 0.9% w/v sodium chloride.

Upon addition to the preservation composition, the preserved platelets can be stored at room temperature, at refrigeration temperatures (0° C.-12° C.) or at freezing temperatures (−80° C.-0° C.) in liquid, frozen, or freeze-dried state to maintain the freshness and functional activity of the platelets. If the platelets will be subsequently frozen or freeze dried, the platelets can be mixed with the preservation composition before freezing.

In one embodiment, the irradiated mixture is stored at 4° C. to 12° C. In another embodiment, the irradiated mixture is stored at 4° C. to 8° C. In yet another embodiment, the platelet mixture is stored at room temperature.

The platelets may be stored for a desired period of time. In certain embodiments, the desired period of time is one, two, three or four weeks, preferably at ambient temperature. Platelet functional activities may be determined by their ability to aggregate in the presence of certain biological agents and their morphology. Platelet function also can be assessed by the maintenance of the pH upon limited storage of a solution containing the platelets and in vivo haemostatic effectiveness using the rabbit kidney injury model described in Krishnamurti et al., Transfusion, 39:967 (1999). Structural integrity of platelets is assessed by in vivo survival following radiolabeling with carbon-15 or indium-111 and identification of the presence of specific platelet antigens.

The platelets may be isolated from the whole blood using methods commonly used in the art. In one embodiment, a unit of whole blood is centrifuged using settings that precipitate only the cellular components of the blood (e.g., red blood cells and white blood cells). At these settings, the platelets remain suspended in the plasma. The platelet-rich plasma (PRP) is removed from the precipitated blood cells, then centrifuged at a faster setting (i.e., at a higher g force) to harvest the platelets from the plasma.

In another embodiment, the whole blood is centrifuged using settings that cause the platelets to become suspended in the “buffy coat” layer, which includes the platelets and the white blood cells. The “buffy coat” is isolated in a sterile bag, suspended in a small amount of red blood cells and plasma, then centrifuged again to separate the platelets and plasma from the red and white blood cells.

In another embodiment, apheresis platelets are collected using a mechanical device that draws blood from the donor and centrifuges the collected blood to separate out the platelets and other components to be collected. The remaining blood is returned to the donor.

The foregoing examples illustrate that an acellular platelet preservation composition for freshly collected platelets can be prepared for improving the functional half-life of platelets. The addition of the platelet preservation composition to freshly collected platelets better maintains the original blood clotting function when infused during the storage period of the platelets. The addition of a platelet preservation composition permits an extended storage of the platelets at refrigeration temperatures and allows the platelets to maintain blood clotting properties without affecting the half-life of the platelets in circulation once transfused. As a result, the platelets stored for an extended period can be used for transfusions while saving a substantial amount of effort and cost.

The present invention is further illustrated by the following examples which should not be construed as limiting. The contents of all references, patents and published patent applications cited throughout this application, as well as the Figures and Tables are incorporated herein by reference.

### EXAMPLES

### Example 1

### General Procedure of Preparing the Preservative Solution

In 50 ml of an acellular chemically modified hemoglobin-based carrier substantially free of red cell membrane (stroma) contaminants, with a hemoglobin concentration of 12-20 gm/dl and a methemoglobin concentration of less than 5%, the following active ingredients are added:

1) a photosensitizer, such as riboflavin, psoralen or methylene blue, to a final concentration of 1-200 μm (riboflavin or psoralin) or 0.2-50 μm (methylene blue), and

2) a platelet activation inhibitor, such as a GPIIb/IIIa antagonist, a thrombin antagonist, a P2Y12 receptor antagonist or a second messenger effector, in an amount of 0.001-5.0 mg.

The above platelet preservation composition is added to the platelets and subjected to a sterilization procedure by exposing to radiation at a desired wave-length. An energy source such as glucose or citrate to sustain aerobic metabolism and electrolytes such as Na, Cl, and Mg, may be added after the sterilization procedure.

TABLE 1 provides the concentration ranges for some commonly used energy sources and electrolytes.

TABLE 1
Commonly Used Energy Sources and Electrolytes

| Component | Concentration (mM ) |
|---|---|
| NaCl | 80 to 120 |
| KCl | 5 to 15 |
| MgCl₂/MgSO₄ | 2 to 5 |
| Na₂ Citrate | 5 to 40 |
| NaH₂PO₄/Na₂ HPO₄ | 5 to 30 |
| Na Acetate | 20 to 40 |
| Na Gluconate | 15 to 30 |
| Glucose | 20 to 50 |
| Maltose | 25 to 35 |
| D-Mannitol | 25 to 40 |

### Example 2

### In Vitro Assessment of Platelet Function and Stability

Cell counts in the platelet concentrates and mean platelet volume were determined electronically using a particle counter. The pH, pO2, pCO2, and bicarbonate levels were determined in a blood gas analyzer. Glucose, lactic acid, and lactic dehydrogenase levels in the platelet concentrates were measured by standard clinical chemistry methodology. Platelet function was measured by aggregometry using ADP and collagen as agonists and by thrombelastography (TEG).

Thrombelastography (TEG)

The principle of TEG is based on the measurement of the physical viscoelastic characteristics of blood clot. Clot formation was monitored at 37° C. in an oscillating plastic cylindrical cuvette (“cup”) and a coaxially suspended stationary piston (“pin”) with a 1 mm clearance between the surfaces, using a computerized Thrombelastograph (TEG Model 3000, Haemoscope, Skokie, Ill.). The cup oscillates in either direction every 4.5 seconds, with a one second mid-cycle stationary period; resulting in a frequency of 0.1 Hz and a maximal shear rate of 0.1 per second. The pin is suspended by a torsion wire that acts as a torque transducer. With clot formation, fibrin fibrils physically link the cup to the pin and the rotation of the cup as affected by the viscoelasticity of the clot (Transmitted to the pin) is displayed on-line using an IBM-compatible personal computer and customized software (Haemoscope Corp., Skokie, Ill.). The torque experienced by the pin (relative to the cup's oscillation) is plotted as a function of time.

TEG assesses coagulation by measuring various parameters such as the time latency for the initial initiation of the clot (R), the time to initiation of a fixed clot firmness (k) of about 20 mm amplitude, the kinetic of clot development as measured by the angle (a), and the maximum amplitude of the clot (MA). The parameter A measures the width of the tracing at any point of the MA. Amplitude in mm is a function of clot strength or elasticity. The amplitude on the TEG tracing is a measure of the rigidity of the clot; the peak strength or the shear elastic modulus attained by the clot, G, is a function of clot rigidity and can be calculated from the maximal amplitude (MA) of the TEG tracing.

The following parameters were measured from the TEG tracing:

R, the reaction time (gelation time) represents the latent period before the establishment of a 3-dimensional fibrin gel network (with measurable rigidity of about 2 mm amplitude).

Maximum Amplitude (MA, in mm), is the peak rigidity manifested by the clot.

Shear elastic modulus or clot strength (G, dynes/cm2) is defined by: G=(5000A)/(100−A).

Blood clot firmness is important function parameters for in vivo thrombosis and hemostasis because the clot must stand the shear stress at the site of vascular injury. TEG can assess the efficacy of different pharmacological interventions on various factors (coagulation activation, thrombin generation, fibrin formation, platelet activation, platelet-fibrin interaction, and fibrin polymerization) involved in clot formation and retraction.

Blood Sampling

Blood is drawn from consenting volunteers under a protocol approved by the Human Investigations Committee of William Beaumont Hospital. Using the two syringe method, samples are drawn through a 21 gauge butterfly needle and the initial 3 ml blood was discarded. Whole blood (WB) is collected into siliconized Vacutainer tubes (Becton Dickinson, Rutherford, N.J.) containing 3.8% trisodium citrate such that a ratio of citrate whole blood of 1:9 (v/v) is maintained. TEG is performed within 3 hrs of blood collection. Calcium is added back at a final concentration of 1-2.5 mM followed by the addition of the different stimulus. Calcium chloride by itself at the concentration used shows only a minimal effect on clot formation and clot strength.

Data are expressed as mean±SEM. Data are analyzed by either paired or group analysis using Student's t-test or ANOVA when applicable; differences are considered significant at P<0.05 or less.

### Example 3

### Preservation Agent Detection Following Removal by Diafiltration

HPLC-based methods were used to define the performance characteristics for assays to detect levels of tirofiban (AGGRASTAT®), eptifibatide (INTEGRILIN®), and argatroban following their removal via diafiltration or following their degradation by ultraviolet light treatment.

The removal of the platelet activation inhibitors was accomplished with the use of tangential flow filtration. Platelet concentrates in 100% plasma, containing either eptifibatide and argatroban, or tirofiban and argatroban, were processed through a hollow fiber filter made of polyethyl sulfone with a pore diameter of 0.5 micron and the inner diameter of the lumen of the filter fiber being 1 mm.

The diafiltration was conducted as a combination of discontinuous and constant volume exchange. Forty milliliter aliquots were processed at a time. A 4 volume discontinuous exchange was done first, which essentially removed most of the plasma proteins. This was followed by a 6 volume constant volume exchange. The flask was sealed. The loss of the permeate was continuously replaced by isotonic saline.

An Agilent XBridge C18 (3.5 μm; 2.1×100 mm) column was used for the method development and sample quantitation experiments below. A flow rate of 0.15 mL/min. was used with Solvent A consisting of Fisher Optima-grade water w/0.1% trifluoroacetic acid (TFA) and Solvent B consisting of Fisher Optima-grade acetonitrile w/0.1% TFA. The gradient sequence is defined in Table 2. Data was recorded at 205 and 230 nm and full spectrum (295-700 nm) by the 168 detector module.

TABLE 2
(Diafiltration)

| Action | Notes | Time (min) |
|---|---|---|
| Injection (25 μL) | | 0 |
| | 10% B | 0-5 |
| Gradient | 10-70% B | 5-15′ |
| | 70-100% B | 15-20′ |
| | 100% B | 20-25′ |
| | 100-10% B | 25-30′ |
| | 10% B | 30-35′ |
| Lamp | Stop Run | |

HPLC-based methods were used to define the performance characteristics for assays for detecting tirofiban, eptifibatide, and argatroban following their removal via diafiltration. These methods employed a Beckman-Coulter System Gold HPLC System equipped with a 126 solvent module, a 168 Multiwavelength diode-array detector; and a 508 autosampler module.

Analytical standard curve data for tirofiban, eptifibatide, and argatroban were generated, which allowed for a preliminary assessment of standard assay performance characteristics, including: assay range, reproducibility, lower limit of detection (LLOD), lower limits of quantitation (LLOQ) (data not shown). The standard curve data was generated in a non-serial manner and in duplicate with analytical sampling occurring as single runs. Tirofiban and eptifibatide were each prepared at 0.1, 0.25, 1, 5, 10, 25, and 50 μg/mL concentrations for assembly of individual standard curves with all dilutions performed in sterile 0.5% saline. eptifibatide also had 100 and 500 μg/mL concentrations tested. Argatroban was prepared at 5, 25, 100, 500, and 1,000 μg/mL concentrations for standard curve assembly with all dilutions performed in sterile 0.5% saline.

To facilitate quantitation of samples treated by diafiltration, human platelet solutions were spiked either with 0.1 μg/mL tirofiban and 0.2 μg/mL eptifibatide or with 0.1 μg/mL tirofiban and 8 μg/mL argatroban. Diafiltration that combines a 4 volume discontinuous exchange, followed by a 10 volume constant volume exchange was undertaken, with 7 samples being tested using an tirofiban/eptifibatide solution, and 3 samples being tested using tirofiban/argatroban solution. All samples were centrifuged at 1,000 g for 15′ to remove platelets immediately after diafiltration. The exchange fluid can be physiologic (0.9%) saline or any other approved platelet preservative solution such as Intersol.

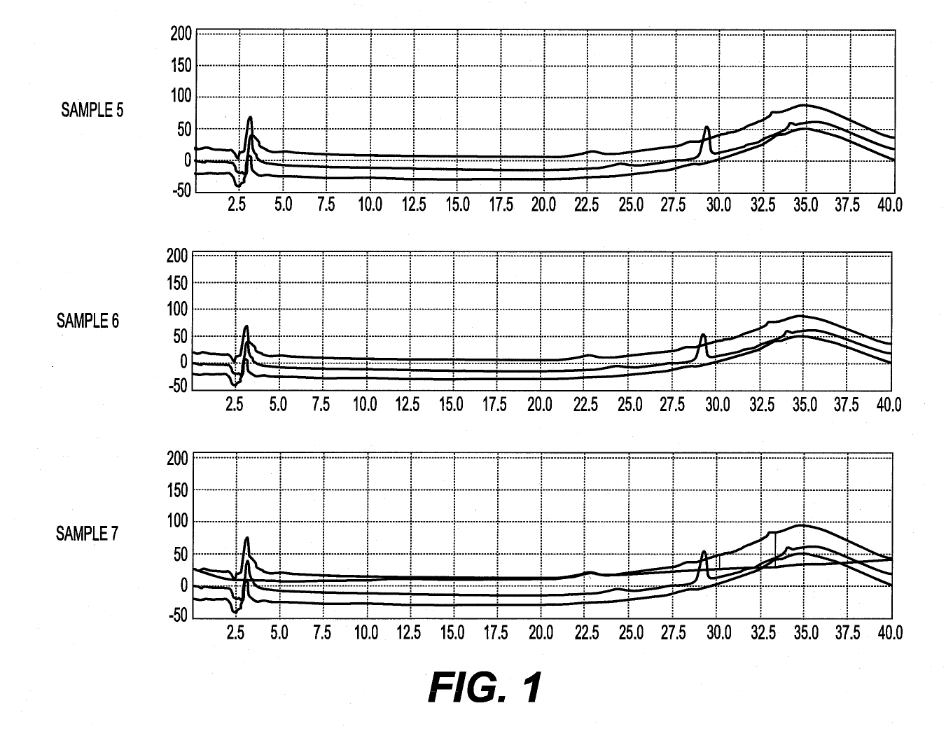

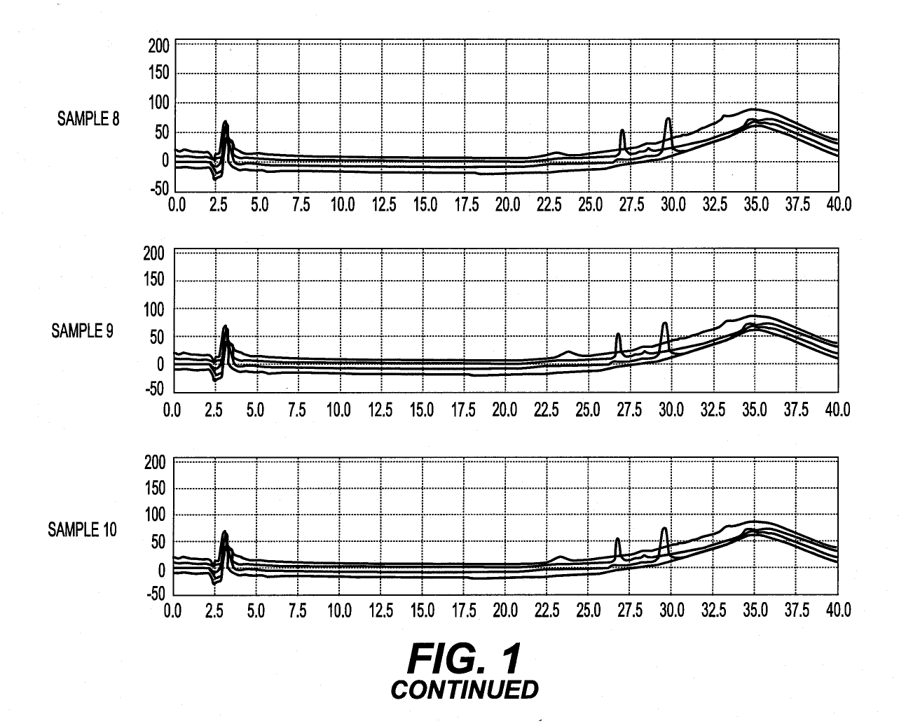

The analysis showed that tirofiban, eptifibatide, and argatroban can be removed from a platelet preservation solution below the level of detection in this analytical system. Analysis of samples 1-10 by HPLC was consistent with these results in terms of depletion of the target agents. Representative traces of samples are provided in FIG. 1. Current estimates would place each agent extraction at >99.99% of control.

### Example 4

### Evaluation of Preservation Agent Photodegradation Upon Exposure to Ultraviolet Light by HPLC Analysis

Stability of tirofiban, eptifibatide, and argatroban was evaluated after exposure to ultraviolet radiation. Individual solutions of 5 μg/mL eptifibatide, 5 μg/mL tirofiban, and 25 μg/mL argatroban were prepared for ultraviolet exposure. A total of 6 exposures were performed at 282 nm and 3 exposures at 308 nm, with each exposure being performed in duplicate prior to HPLC analysis. The exposure were varied to provide varying UV dose. This is accomplished by a combination increased intensity and exposure time. A non-exposed control specimen was also processed for each series. Samples were coded for exposure and were analyzed neat using further refined HPLC methods modified as further defined below.

The HPLC analysis was conducted using a Beckman-Coulter System Gold HPLC System equipped with a 126 solvent module, a 168 Multiwavelength diode-array detector; and a 508 autosampler module. A Shimadzu ShimPac ODS (3.5 μm; 2.0×30 mm) column was employed, wherein a flow rate of 0.2 mL/min. was used with Solvent A consisting of Fisher Optima-grade water w/0.1% trifluoroacetic acid (TFA) and Solvent B consisting of Fisher Optima-grade Methanol w/0.1% TFA. The gradient sequence is defined in Tables 3 and 4. All data was recorded at 230 and 280 nm and full spectrum (295-700 nm) by the 168 detector module.

TABLE 4
(Eptifibatide)

| Action | Notes | Time (min) |
|---|---|---|
| Injection (25 μL) | | 0 |
| | 5% B | 0-5 |
| Gradient | 5-100% B | 5-10′ |
| | 100% B | 10-13′ |
| | 100-5% B | 13-16′ |
| | 5% B | 16-25′ |
| Lamp | Stop Run | |

The refined HPLC conditions provided a faster and more reproducible method for these applications, which are readily translatable to LC-MS/MS. Standard curves generated for the three agents tested allowed for a determination of the performance characteristics depicted in Table 5 below:

TABLE 5
Performance characteristics of agents tested with the refined
chromatographic conditions.

| Preservation Agent | Tirofiban | | Argatroban | | Eptifibatide | |
|---|---|---|---|---|---|---|
| Elution time | 19.3 | min | 19.9 | min | 17.9 | min |
| Range tested | 0.625-20 | μg/mL | 1-50 | μg/mL | 1.25-10 | μg/mL |
| LLOD* | 0.625 | μg/mL | 1 | μg/mL | 1.25 | μg/mL |
| LLOQ* | 2.5 | μg/mL | 1 | μg/mL | 2.5 | μg/mL |

| | | | |
|---|---|---|---|
| % CV (curve | 0.98 | 1.81 | 9.40 |
| average) | | | |

*Based on linear fit. A 5-point parametric fit may be able to extend the effective assay range.

Argatroban Exposure to UV_{282 nm}

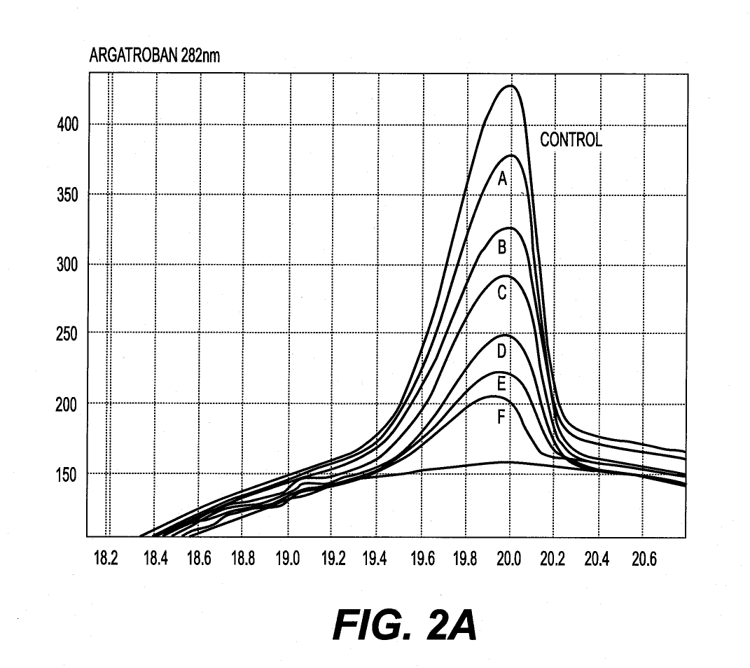

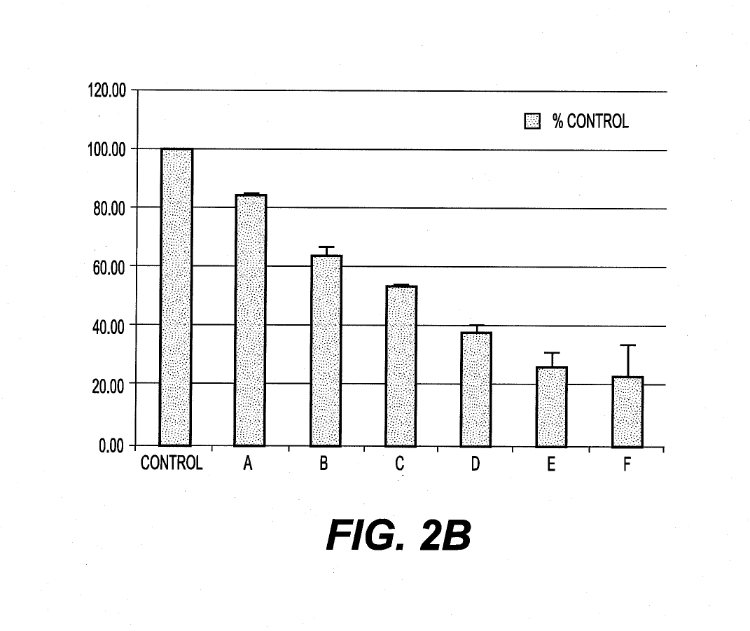

The dose-dependent photodegradation of argatroban upon exposure to UV light at 282 nm is shown in FIGS. 2A and 2B. FIG. 2A shows HPLC traces of exposures A-F compared to a control (unexposed 50 μg/mL argatroban) and a saline blank. FIG. 2B (right) is a graphical representation of the loss in peak height associated with the exposure to UV₂₈₂ with standard deviations.

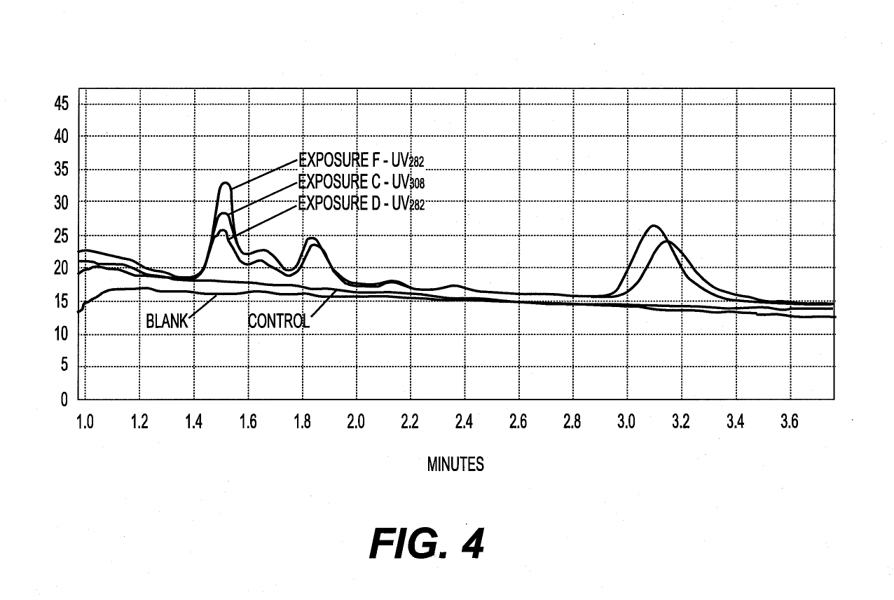

Relative areas were as follows: Control—100%; exposure A—84.5%, exposure B—64.7%, exposure C—53.9%, exposure D—38.1%, exposure E—26.7%, and exposure F—23.2%. Although a steady loss in argatroban was observed at 19.9 minutes (A_{230 nm}), there was no emergence of a secondary peak in the chromatogram of comparable area to account for discrete photo bleached degradation products. However, a series of species with areas <5% of the original peaks were observed at 18.9′, 16.8′, 2.83°, and 1.47′ were observed, as well as minor species (areas <1% control) at 18.5′, 18.2′, 17.8′, 17.5′, 3.15′, 2.05′, and 1.77°. FIG. 4 depicts several degradation products associated with the ultraviolet light treatment.

Argatroban Exposure to UV_{308 nm}

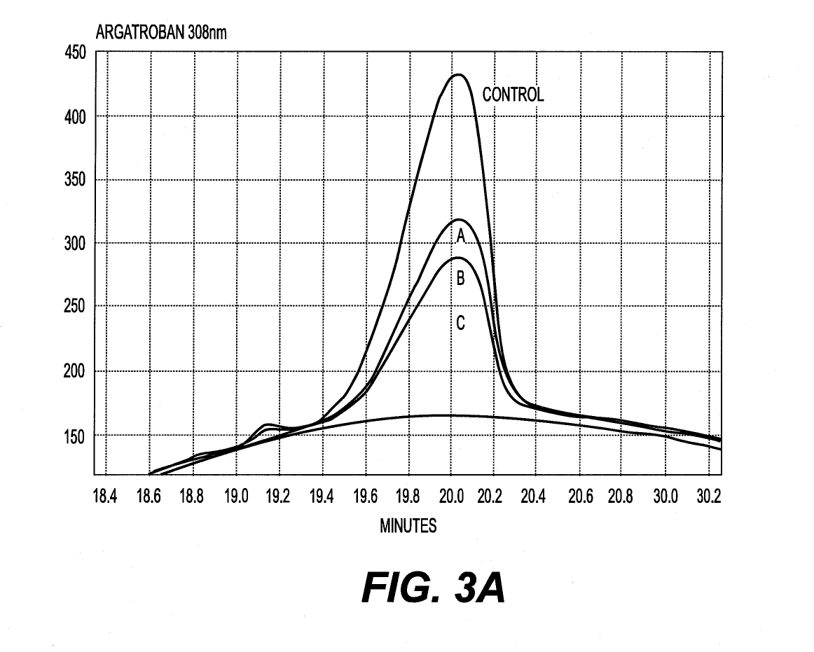

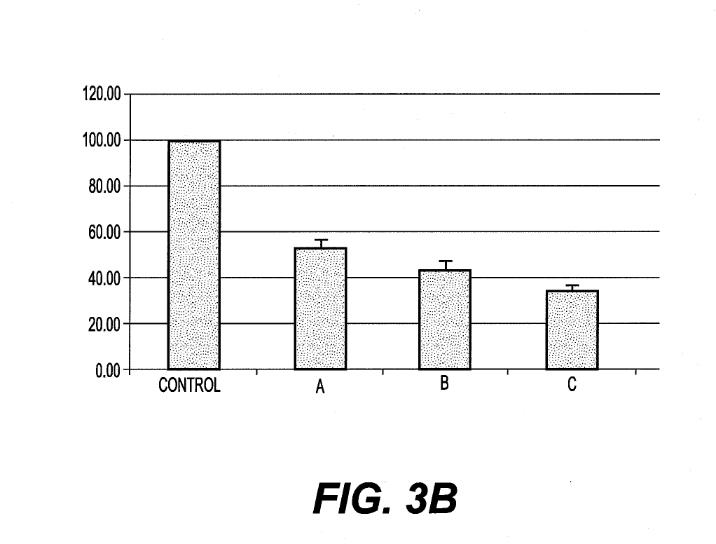

FIGS. 3A and 3B depict a similar set of observations for argatroban exposure to UV₃₀₈. FIG. 3A shows HPLC traces of exposures A-C in relation to a control (unexposed 50 μg/mL argatroban) and a saline blank. FIG. 3B is a graphical representation of the loss in peak height associated with the exposure of argatroban to UV₃₀₈ expressed as % relative to control with standard deviations.

This data suggests that ‘exposure A’ at UV₃₀₈ has approximately the same impact as ‘exposure C’ at UV₂₈₂. FIG. 4 shows representative traces reflecting an identical pattern of photodegradation products at UV₂₈₂ and UV₃₀₈ in the two sets of experiments exemplified in FIGS. 2 and 3.

Tirofiban Exposure to UV_{282 nm}

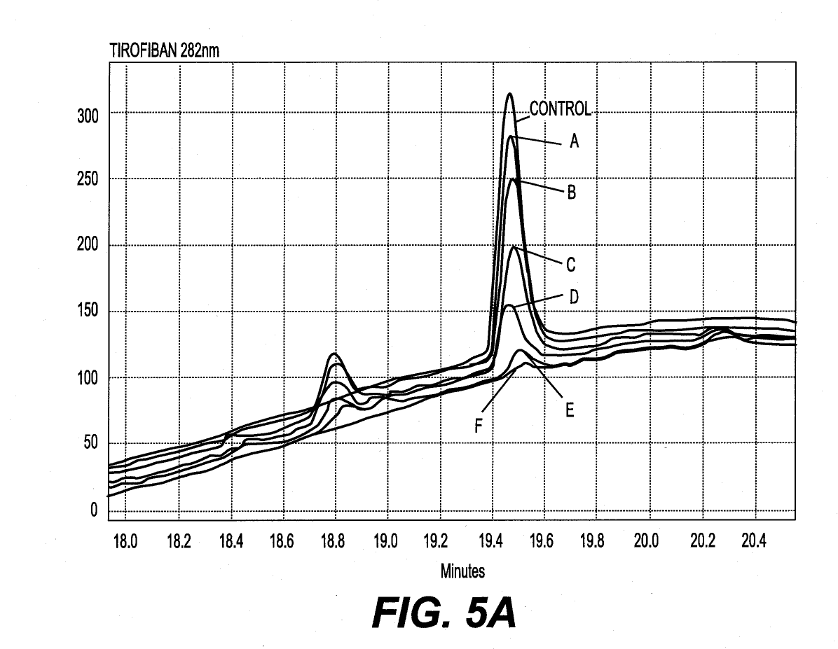

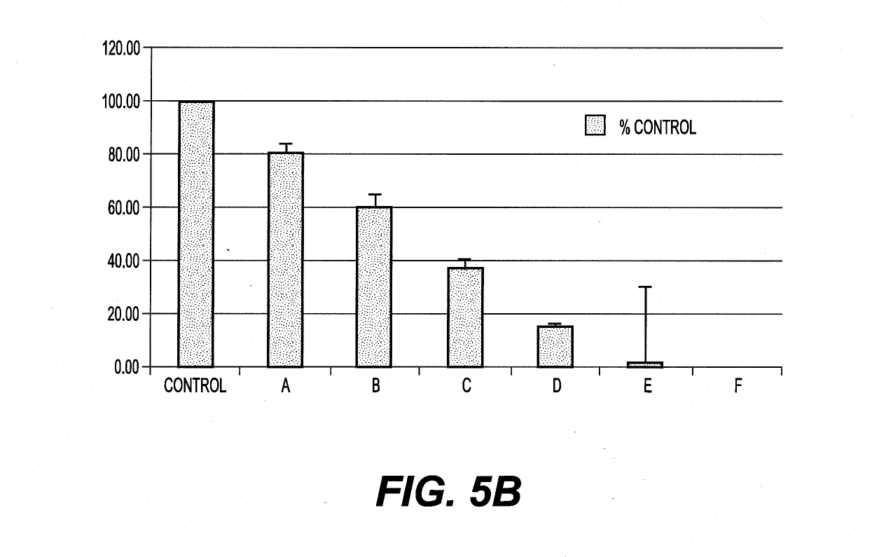

Tirofiban exposure to UV_{282 nm} provided a graduated photodegradation profile, as shown in FIGS. 5A and 5B. FIG. 5A shows HPLC traces of exposures A-F in reference to a control (unexposed 5 μg/mL tirofiban) and a saline blank. FIG. 5B is a graphical representation of the loss in peak height associated with the exposure to UV₃₀₈ expressed as % relative to a control with standard deviations shown. Traces E and F were below the LLOQ for the assay.

Dose-dependent UV₂₈₂ photodegradation for tirofiban was observed as follows: Control—100%; exposure A—81.2%; exposure B—59.9%; exposure C—37.7%; exposure D—15.4%; exposure E—1.5%; and exposure F—indeterminate. Four discernable degradation products were observed at 20.1′, 18.7′, 18.2′, and 17.5′, with the 18.2′ peak (corresponding to exposure C) being the first appearing and most intense. An examination of the full spectrum (A_{295-700 nm}) failed to reveal absorptive species at any other wavelengths.

Tirofiban Exposure to UV_{308 nm}

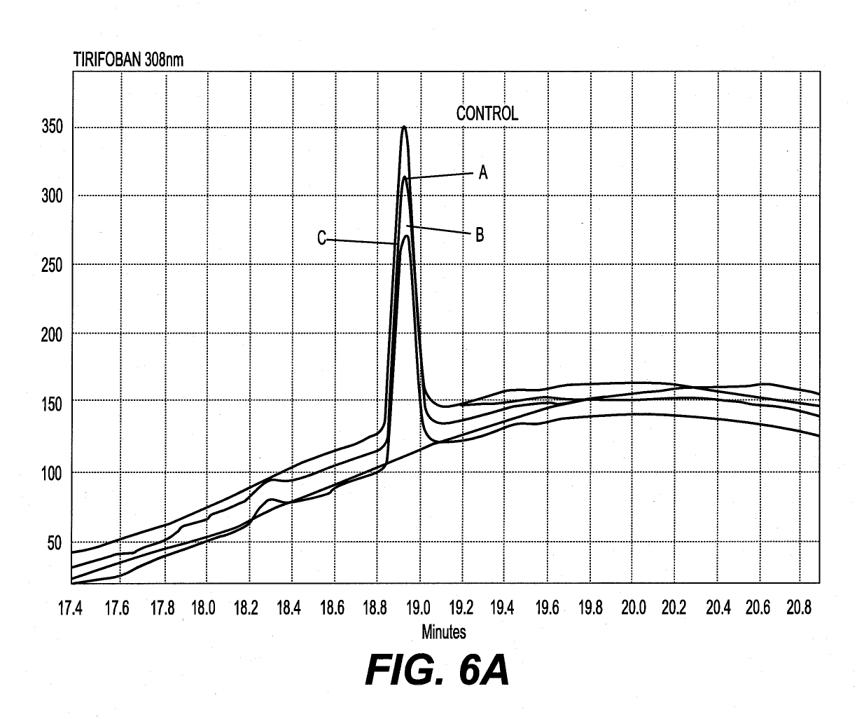

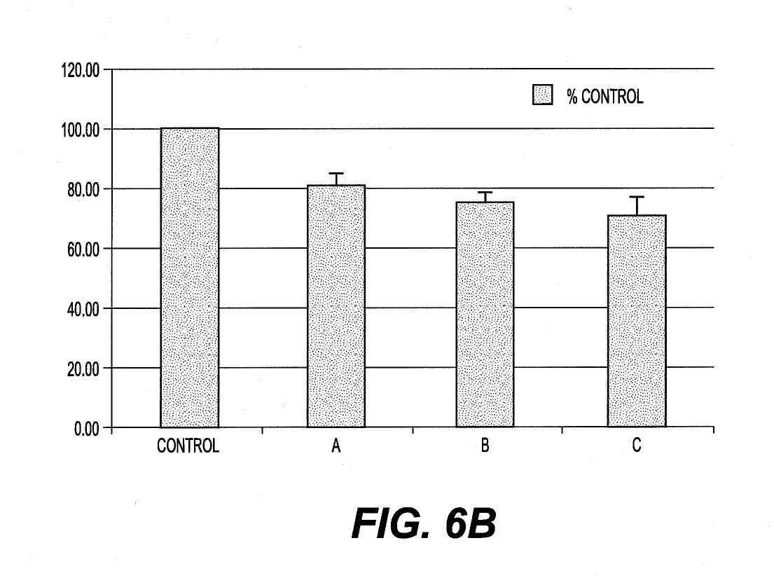

As shown in FIGS. 6A and 6B, the results for tirofiban exposure to UV₃₀₈ followed a dissimilar trend as seen with argatroban exposure at UV₃₀₈. That is, there was little photodegradation of the tirofiban at UV₃₀₈. FIG. 6A shows HPLC traces of exposures A-C in reference to a control (unexposed 5 μg/mL tirofiban) and a saline blank. FIG. 6B is a graphical representation of the loss in peak height associated with exposure to UV₃₀₈ expressed as % relative to control with standard deviations shown. The degradation profile was as follows: Exposure A—81.2%, B—76.9%, and C—73.0% relative to control.

Eptifibatide Exposure to UV_{282 nm}

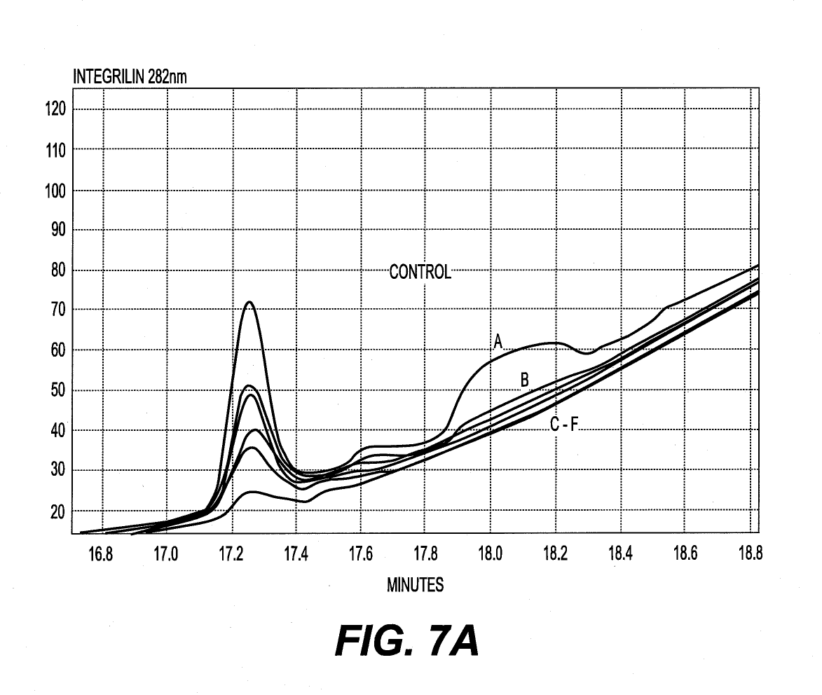

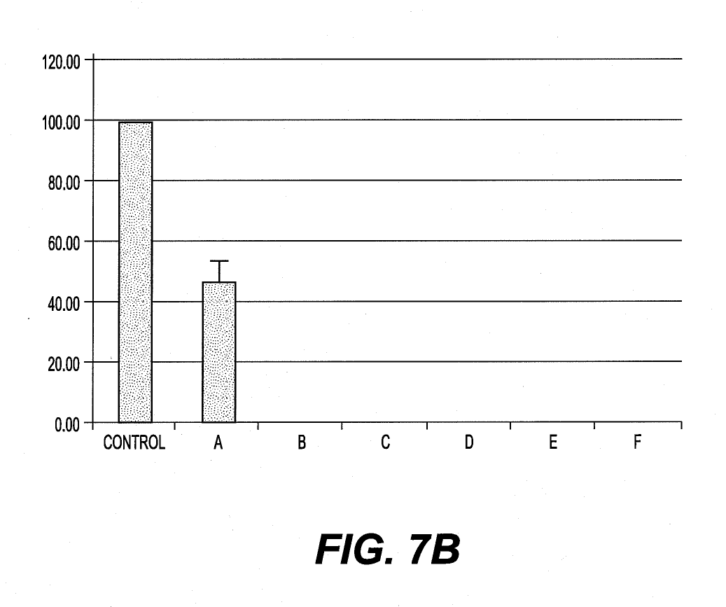

As shown in FIGS. 7A and 7B, eptifibatide (INTEGRILIN®) exposure to UV_{282 nm} provided a faster photodegradation profile than the other compounds tested. FIG. 7A shows HPLC traces of exposures A-F in reference to a control (unexposed 5 μg/mL eptifibatide) and a saline blank. FIG. 7B is a graphical representation of the loss in peak height associated with the exposure to UV₃₀₈ expressed as % relative to control. Exposure A was 47.0% relative to control, with the remainder of the exposures being below the LLOD. Notably, an additional species at 17.3 appeared to grow more intense with the initial exposures, but did not increase in intensity at higher exposures. It is possible this product degraded further, though there is no evidence of this in the remainder of the chromatogram. No other absorptive species was observed when examined on full spectrum scan (A_{295-700 nm}). Exposure at UV₃₀₈ resulted in substantial photodegradation, but to a lesser extent than at UV₂₈₂, (assuming dosages are equivalent).

Eptifibatide Exposure to UV_{308 nm}

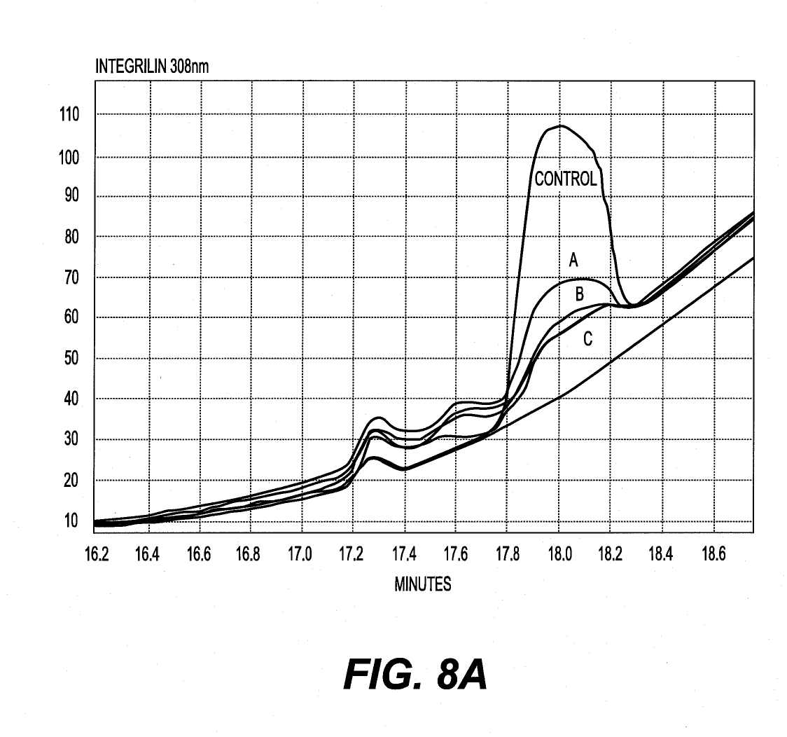

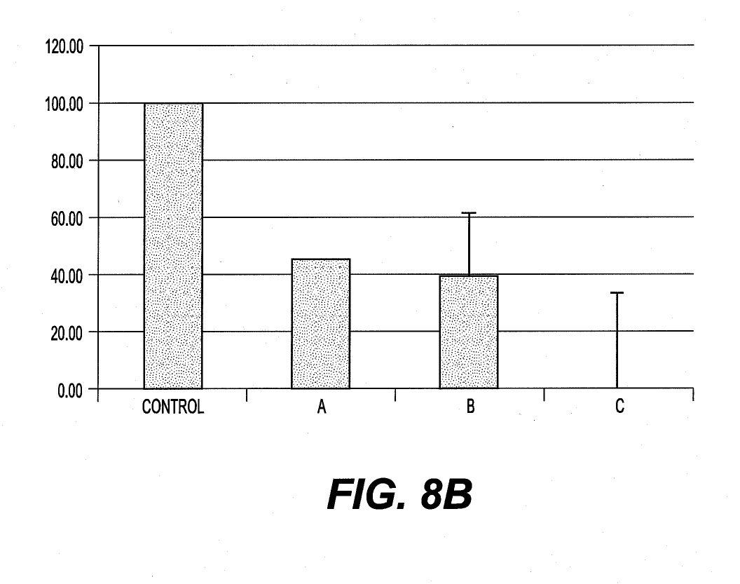

FIGS. 8A and 8B shows a photodegradation profile of eptifibatide (INTEGRILIN®) at UV₃₀₈. FIG. 8A shows HPLC traces of exposures A-C in reference to a control (unexposed 5 μg/mL eptifibatide) and a saline blank. FIG. 8B is a graphical representation of the loss in peak height associated with the exposure to UV₃₀₈ expressed as % relative to control and with standard deviations shown. For eptifibatide, similar degradation products were observed at either wavelength.

Photodegradation of the three agents proceeded in a similar nature independent of wavelength used, with degradation products noted in the results. Assuming the alpha-numeric codes for dosages were equivalent, the relative stabilities are as follows:

UV₂₈₂: argatroban>tirofiban>>eptifibatide

UV₃₀₈: tirofiban>>argatroban>>eptifibatide

### Example 5

### Preservation of Platelets

To 300 ml platelet preparation that is suspended in 70% Intersol and 30% plasma, 17.5 ml of Amotosalen-HCl is added to a final concentration of 150 μM. The platelet preparation is then exposed to UVA light (320-400 nm) at a dose of 3 J/cm² for 4-6 minutes while the platelets are being shaken gently. Immediately following this process, 48 μg tirofiban and 2.5 mg argatroban are added to the platelet preparation. Amotosalen and the free photoproducts resulting from the UV exposure are removed in a compound adsorption device (CAD) for 4-16 hours. The platelet preparation is then stored according to standard Blood Bank protocol and analyzed for platelet morphology, ESC, HSR, thromboelastography, response to agonist such as ADP and collagen, in vivo 24 hour CCI and circulation half-life.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates the contrary.

What is claimed is:

1. A method for preserving platelets, comprising:
(a) irradiating a platelet mixture having an effective amount of a photosensitizer under conditions sufficient to activate the photosensitizer and inactivate microbes in the platelet mixture to form a microbe-depleted platelet preparation, and
(b) adding to the microbe-depleted platelet preparation a plurality of platelet preservation agents, including:
(i) an effective amount of a platelet activation inhibitor selected from the group consisting of GPIIb antagonists, GPIIIa antagonists, bifunctional inhibitors of both GPIIb and IIIa, P2Y12 receptor antagonists, second messenger effectors, derivatives thereof, and combinations thereof; and
(ii) an effective amount of an anticoagulant selected from the group consisting of factor Xa inhibitor and factor IIa inhibitor thereby forming a platelet preservation composition.

2. The method of claim 1, further comprising adding at least one mitochondrial-targeted antioxidant to the microbe-depleted platelet preparation.

3. The method of claim 2, wherein the mitochondrial-targeted antioxidant is mitoquinone, mitoquinol, MitoQ, Mito-TEMPOL, MitoVit E or MitoPBN.

4. The method of claim 1, wherein prior to step (a), a second plurality of platelet preservation agents are added to the platelet mixture.

5. The method of claim 4, wherein the second plurality of preservation agents are the same as the first plurality of preservation agents.

6. The method of claim 1, wherein the platelet activation inhibitor is a GPIIb or GPIIIa antagonist and the anticoagulant is a thrombin inhibitor.

7. The method of claim 1, wherein the platelet activation inhibitor is tirofiban and the anticoagulant is argatroban.

8. The method of claim 1, wherein the photosensitizer is selected from the group consisting of riboflavin, psoralen, amotosalen, methylene blue, perylene and perylene bisimide.

9. The method of claim 1, further comprising adding to the microbe-depleted platelet mixture one or more: calpain inhibitors, cyclophilin D inhibitors, p38 mitogen-activated kinase (MAPK) inhibitors, phosphoinositide-3-kinase/Akt signaling pathway inhibitors, chloride channel inhibitors, calcium modulating agents, caspase inhibitors, protein synthesis inhibitors, sialidase inhibitors or a combination thereof.

10. The method of claim 9, wherein a calpain inhibitor is added to the microbe-depleted platelet mixture.

11. The method of claim 10, wherein the calpain inhibitor is selected from the group consisting of PD150606, PD151746, calpastatin, calpeptin, ABT-099, A-965431, A-705253, A-705239, MDL28170, Z-LLY-fmk, Z-VAD-fmk and ALLN.

12. The method of claim 9, wherein a cyclophilin D inhibitor is added to the microbe-depleted platelet mixture.

13. The method of claim 12, wherein the cyclophilin D inhibitor is selected from the group consisting of cyclosporin A, rotenone and oligomycin.

14. The method of claim 9, wherein an inhibitor of p38 mitogen activated protein kinase is added to the microbe-depleted platelet mixture.

15. The method of claim 14, wherein the inhibitor of p38 mitogen activated protein kinase is selected from the group consisting of SB202190, SB203580 and LY294002.

16. The method of claim 9, wherein a phosphoinositide-3-kinase/Akt signaling pathway inhibitor is added to the microbe-depleted platelet mixture.

17. The method of claim 16, wherein the phosphoinositide-3-kinase/Akt signaling pathway inhibitor is selected from the group consisting of phosphoinositide 3-kinase (PI3K), phosphoinositide-dependent protein kinase 1 (PDK1), protein kinase B, glycogen synthase kinase 3β (GSK-3β) and combination thereof.

18. The method of claim 9, wherein a chloride channel inhibitor is added to the microbe-depleted platelet mixture.

19. The method of claim 18, wherein the chloride channel inhibitor is selected from the group consisting of CaCCinh-A01, T16Ainh-A01 and NPPB.

20. The method of claim 9, wherein a calcium modulating agent is added to the microbe-depleted platelet mixture and wherein the calcium modulating agent is selected from the group consisting of BAPTA, EGTA, CDTA, BAPTA-AM, EGTA-AM and CDTA-AM.

21. The method of claim 10, wherein a caspase inhibitor is added to the microbe-depleted platelet mixture.

22. The method of claim 9, wherein the caspase inhibitor is selected from the group consisting of Z-DEVD-fmk, Ivachtin, AZ 10417808 and Z-VAD-fmk.

23. The method of claim 10, wherein a protein synthesis inhibitor is added to the microbe-depleted platelet mixture.

24. The method of claim 23, wherein the protein synthesis inhibitor is selected from the group consisting of zilascorb zilascorb(2H), anisomycin, emetine and rapamycin.

25. The method of claim 9, wherein a sialidase inhibitor is added to added to the microbe-depleted platelet mixture.

26. The method of claim 1, further comprising the step of removing one or more of the photosensitizer, platelet activation inhibitor and anticoagulant from the platelet preservation composition.

27. The method of claim 26, wherein one or more of the photosensitizer, platelet activation inhibitor and anticoagulant is removed with a compound adsorption device.

28. The method of claim 26, wherein one or more of the photosensitizer, platelet activation inhibitor and anticoagulant is removed by passing the preserved platelet composition through a tangential flow filtration (TFF) device having a TFF filter with an average pore size of 500 dalton to 5 μm.

29. The method of claim 28, wherein the TFF device is a diafiltration device with a diafiltration buffer.

30. The method of claim 28, wherein the TFF filter is a hollow fiber membrane filter.

31. A platelet preservation composition, comprising:
an irradiated photosensitizer selected from the group consisting of riboflavin, psoralen or amotosolen; and
a PSL inhibitor selected from the group consisting of mitochondrial-targeted antioxidant, calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof,
wherein said PSL inhibitor is present in an amount effective to reduce or prevent one or more changes characteristic of platelet storage lesion.

32. A preserved platelet preparation, comprising:
an irradiated platelet preparation,
a platelet activation inhibitor selected from the group consisting of GPIIb antagonists, GPIIIa antagonists, bifunctional inhibitors of both GPIIb and IIIa, P2Y12 receptor antagonists, second messenger effectors, derivatives thereof, and combinations thereof;
an anticoagulant selected from the group consisting of factor Xa inhibitor and factor IIa inhibitor; and
a PSL inhibitor selected from the group consisting of mitochondrial-targeted antioxidant, calpain inhibitor, cyclophilin D inhibitor, p38 mitogen-activated kinase (MAPK) inhibitor, phosphoinositide-3-kinase/Akt signaling pathway inhibitor, chloride channel inhibitor, calcium modulating agent, caspase inhibitor, protein synthesis inhibitor, sialidase inhibitor and combination thereof,
wherein said PSL inhibitor is present in an amount effective to reduce or prevent one or more changes characteristic of platelet storage lesion.
